(19) United States
(12) Patent Application Publication
(10) Pub. No.: US 2025/0231521 A1
(43) Pub. Date: Jul. 17, 2025

(54) ELECTROPHOTOGRAPHIC APPARATUS

(71) Applicant: CANON KABUSHIKI KAISHA, Tokyo (JP)

(72) Inventors: KENICHI IKARI, Chiba (JP); HARUHIKO MITSUDA, Chiba (JP); NAOAKI ICHIHASHI, Chiba (JP); KENTARO KAMAE, Kanagawa (JP)

(21) Appl. No.: 19/002,348

(22) Filed: Dec. 26, 2024

(30) Foreign Application Priority Data
Jan. 12, 2024 (JP) 2024-003389
Aug. 28, 2024 (JP) 2024-146848
Oct. 8, 2024 (JP) 2024-176750

(51) Int. Cl. G03G 21/18; G03G 5/05; G03G 5/06; G03G 9/087

(52) U.S. Cl. CPC G03G 21/1814; G03G 5/0578; G03G 5/0653; G03G 9/08755

(57) ABSTRACT

Provided is an electrophotographic apparatus that suppresses the occurrence of a pattern memory and enables stable image formation under a high-temperature and high-humidity environment. The electrophotographic apparatus includes: an electrophotographic photosensitive member; a charging unit; an image exposing unit; a developing unit including a toner; a transfer unit; a cleaning unit; and a fixing unit. The electrophotographic photosensitive member includes a monolayer-type photosensitive layer containing a binder resin, a charge-generating substance, a hole-transporting substance, an electron-transporting substance, and silicon atom-containing particles. The monolayer-type photosensitive layer is a surface layer of the electrophotographic photosensitive member. The charge-generating substance is one of metal-free phthalocyanine or oxytitanium phthalocyanine. The silicon atom-containing particles are one of silica particles or silicone resin particles. The toner includes toner particles each containing a polyester resin having a polyethylene terephthalate segment.

### BACKGROUND OF THE INVENTION

### Field of the Invention

The present disclosure relates to an electrophotographic apparatus.

### Description of the Related Art

An organic electrophotographic photosensitive member in which a photosensitive layer (organic photosensitive layer) using an organic material as a photoconductive substance (a charge-generating substance or a charge-transporting substance) is arranged on a support is widely used as an electrophotographic photosensitive member to be mounted on an electrophotographic apparatus.

As the photosensitive layer, a configuration containing a charge-generating substance, a charge-transporting substance, and a binder resin is known. For example, in Japanese Patent Application Laid-Open No. 2015-87500, there is described a technology for improving the electrical characteristics and wear resistance of the photosensitive member through use of a specific polycarbonate resin.

In addition, in recent years, in order to reduce the energy usage amount of the electrophotographic apparatus, there has been proposed a technology for fixing a toner at low temperature. In Japanese Patent Application Laid-Open No. 2004-280085, there is described a technology regarding a toner containing, as one of resin components, a polyester obtained by causing polyethylene terephthalate, an alcohol component, and a carboxylic acid component to react with each other.

### SUMMARY OF THE INVENTION

The inventors have made investigations, and as a result, have found that, when the technologies disclosed in Japanese Patent Application Laid-Open No. 2015-87500 and Japanese Patent Application Laid-Open No. 2004-280085 are simultaneously used, there is room for improvement in pattern memory under a high-temperature and high-humidity environment.

The pattern memory refers to a phenomenon in which, when an image pattern including a solid black band portion in a drum circumferential direction in part of an output image is repeatedly output, and then a full-screen halftone image without the solid black band portion is output, a portion that has been the solid black band portion of the image pattern including the solid black band portion is output under a state having a density difference in the full-screen halftone image.

The inventors have made investigations, and as a result, have found that, when an image is formed through use of an electrophotographic photosensitive member containing metal-free phthalocyanine or oxytitanium phthalocyanine as a charge-generating substance in a surface layer and a toner containing a polyester resin having a polyethylene terephthalate segment under a high-temperature and high-humidity environment, there occurs a technical problem in that the pattern memory is liable to occur in an output image.

An object of the present disclosure is to provide an electrophotographic apparatus that suppresses the occurrence of a pattern memory and enables stable image formation under a high-temperature and high-humidity environment.

According to the present disclosure, there is provided an electrophotographic apparatus including: an electrophotographic photosensitive member; a charging unit configured to charge a surface of the electrophotographic photosensitive member; an image exposing unit configured to irradiate the charged surface of the electrophotographic photosensitive member with image exposure light to form an electrostatic latent image on the surface of the electrophotographic photosensitive member; a developing unit, which includes a toner, and which is configured to develop the electrostatic latent image with the toner to form a toner image on the surface of the electrophotographic photosensitive member; a transfer unit configured to transfer the toner image from the surface of the electrophotographic photosensitive member onto a transfer material; a cleaning unit configured to remove a residual toner remaining on the surface of the electrophotographic photosensitive member with a cleaning blade after the toner image is transferred from the surface of the electrophotographic photosensitive member onto the transfer material; and a fixing unit configured to fix the toner image transferred onto the transfer material to the transfer material, wherein the electrophotographic photosensitive member includes a monolayer-type photosensitive layer containing a binder resin, a charge-generating substance, a hole-transporting substance, an electron-transporting substance, and silicon atom-containing particles, wherein the monolayer-type photosensitive layer is a surface layer of the electrophotographic photosensitive member, wherein the charge-generating substance is one of metal-free phthalocyanine or oxytitanium phthalocyanine, wherein the silicon atom-containing particles are one of silica particles or silicone resin particles, and wherein the toner includes toner particles each containing a polyester resin having a polyethylene terephthalate segment.

Further features of the present invention will become apparent from the following description of exemplary embodiments with reference to the attached drawings.

### BRIEF DESCRIPTION OF THE DRAWINGS

FIG. 1 is a view for illustrating an example of a process cartridge including an electrophotographic photosensitive member of the present disclosure.

FIG. 2 is a view for illustrating an example of an electrophotographic apparatus including the electrophotographic photosensitive member of the present disclosure.

### DESCRIPTION OF THE EMBODIMENTS

The present invention is described in detail below by way of exemplary embodiments.

Investigations made by the inventors have clarified that, when an image is formed through use of an electrophotographic photosensitive member containing metal-free phthalocyanine or oxytitanium phthalocyanine as a charge-generating substance in a surface layer and a toner containing a polyester resin having a polyethylene terephthalate segment under a high-temperature and high-humidity environment, there occurs a technical problem in that a pattern memory is liable to occur in an output image.

The inventors have assumed the reasons for the occurrence of the technical problem in which the pattern memory is liable to occur to be as described below.

In the electrophotographic photosensitive member containing metal-free phthalocyanine or oxytitanium phthalocyanine as a charge-generating substance in a surface layer, the sensitivity of the electrophotographic photosensitive member may be influenced by the amount of moisture (humidity) in air under a usage environment. When the sensitivity of the electrophotographic photosensitive member is changed by the amount of moisture on the surface of the electrophotographic photosensitive member, this change leads to the occurrence of a density difference in a halftone image. That is, the foregoing may cause the occurrence of the pattern memory.

Meanwhile, the toner containing a polyester resin having a polyethylene terephthalate segment tends to have higher polarity as compared to a polyester resin that is generally used in a toner, and hence the affinity for water thereof tends to be increased. As a result, when the toner is present on the surface of the electrophotographic photosensitive member, the amount of moisture on the surface of the electrophotographic photosensitive member becomes higher than the amount of moisture in air under a usage environment. This influence becomes significant under a high-temperature and high-humidity environment.

When an image is formed through use of the electrophotographic photosensitive member containing metal-free phthalocyanine or oxytitanium phthalocyanine as a charge-generating substance in a surface layer and the toner containing a polyester resin having a polyethylene terephthalate segment under a high-temperature and high-humidity environment, the amount of moisture present on the surface of the toner having high polarity is large, and hence the amount of moisture present on the surface of the electrophotographic photosensitive member that is brought into contact with the toner is also increased. When a solid black band image is output, the amount of the toner present on the surface of the electrophotographic photosensitive member is increased, and hence the influence of an increase in amount of moisture on the surface of the electrophotographic photosensitive member is also increased. The moisture on the surface of the electrophotographic photosensitive member influences the sensitivity of the charge-generating substance, resulting in a sensitivity difference between a solid black band portion and a solid white band portion. It is conceived that, when an image is output under a state in which a sensitivity difference remains, a density difference occurs between the solid black band portion and the solid white band portion, and this density difference appears on the image as a pattern memory.

The inventors have made investigations, and as a result, have found that, when silica particles or silicone resin particles are incorporated as silicon atom-containing particles into the surface layer of the electrophotographic photosensitive member, an electrophotographic apparatus having a pattern memory suppressed is obtained.

The inventors have assumed the reasons for which the electrophotographic apparatus of the present disclosure is excellent in pattern memory-suppressing effect to be as described below.

The surface layer of the electrophotographic photosensitive member of the present disclosure contains a binder resin, a hole-transporting substance, an electron-transporting substance, and silicon atom-containing particles together with a charge-generating substance. It has been assumed that, in the surface layer of the electrophotographic photosensitive member, in particular, the silicon atom-containing particles interposed between the surface of the electrophotographic photosensitive member and the charge-generating substance present in the surface layer suppress the influence of moisture on the charge-generating substance from the surface of the electrophotographic photosensitive member. When the influence of moisture on the charge-generating substance from the surface of the electrophotographic photosensitive member is reduced, a change in sensitivity caused by the influence of moisture becomes small to suppress a pattern memory.

### <Electrophotographic Photosensitive Member>

The electrophotographic photosensitive member of the electrophotographic apparatus of the present disclosure includes a monolayer-type photosensitive layer containing a binder resin, a charge-generating substance, a hole-transporting substance, an electron-transporting substance, and silicon atom-containing particles, and the monolayer-type photosensitive layer forms the surface layer of the electrophotographic photosensitive member.

In addition, the electrophotographic photosensitive member of the electrophotographic apparatus of the present disclosure is characterized by including a surface layer containing metal-free phthalocyanine or oxytitanium phthalocyanine as the charge-generating substance and containing silica particles or silicone resin particles as the silicon atom-containing particles.

In addition, the electrophotographic photosensitive member of the present disclosure may also include a support, a conductive layer, and an undercoat layer described later in addition to the surface layer.

An example of a method of producing the electrophotographic photosensitive member of the present disclosure is a method including preparing a coating liquid for each layer described later, applying the liquid in a desired layer order, and drying the liquid. In this case, examples of a method of applying each of the coating liquids include dip coating, spray coating, inkjet coating, roll coating, die coating, blade coating, curtain coating, wire bar coating, and ring coating. Of those, dip coating is preferred from the viewpoints of efficiency and productivity.

Each of the layers is described below.

### <Support>

The electrophotographic photosensitive member of the present disclosure preferably includes a support. The support of the electrophotographic photosensitive member is preferably a support having conductivity (conductive support). In addition, examples of the shape of the support include a cylindrical shape, a belt shape, and a sheet shape. Of those, a cylindrical support is preferred. In addition, the surface of the support may be subjected to electrochemical treatment such as anodic oxidation, blast treatment, or cutting treatment.

A metal, a resin, glass, or the like is preferred as a material for the support.

Examples of the metal include aluminum, iron, nickel, copper, gold, stainless steel, and an alloy thereof. Of those, an aluminum support using aluminum is preferred.

In addition, it is preferred that conductivity be imparted to the resin or the glass by treatment, such as mixing or coating with a conductive material.

### <Conductive Layer>

A conductive layer may be arranged on the support. When the conductive layer is arranged, scratches and irregularities on the surface of the support can be hidden, and the reflection of light on the surface of the support can be controlled.

The conductive layer preferably contains conductive particles and a resin.

A material for the conductive particles is, for example, a metal oxide, a metal, or carbon black.

Examples of the metal oxide include zinc oxide, aluminum oxide, indium oxide, silicon oxide, zirconium oxide, tin oxide, titanium oxide, strontium titanate, magnesium oxide, antimony oxide, and bismuth oxide. Examples of the metal include aluminum, nickel, iron, nichrome, copper, zinc, and silver.

Of those, metal oxide particles are preferably used as the conductive particles, and in particular, titanium oxide particles, tin oxide particles, and zinc oxide particles are more preferably used.

When the metal oxide particles are used as the conductive particles, the surface of each of the metal oxide particles may be treated with a silane coupling agent or the like, or the metal oxide particles may each be doped with an element, such as phosphorus or aluminum, or an oxide thereof.

In addition, each of the conductive particles may have a laminate configuration including a core particle and a coating layer coating the particle. Examples of the core particle include a titanium oxide particle, a barium sulfate particle, and a zinc oxide particle. Examples of the coating layer include metal oxide particles such as tin oxide.

In addition, when the metal oxide particles are used as the conductive particles, the volume-average particle diameter thereof is preferably 1 nm or more and 500 nm or less, more preferably 3 nm or more and 400 nm or less.

Examples of the resin include a polyester resin, a polycarbonate resin, a polyvinyl acetal resin, an acrylic resin, a silicone resin, an epoxy resin, a melamine resin, a polyurethane resin, a phenol resin, and an alkyd resin.

In addition, the conductive layer may further contain a silicone oil, resin particles, a concealing agent, and the like. An example of the concealing agent is titanium oxide.

The conductive layer may be formed by: preparing a coating liquid for a conductive layer containing each of the above-mentioned materials and a solvent; forming a coat thereof on the support; and drying the coat. Examples of the solvent to be used in the coating liquid for a conductive layer include an alcohol-based solvent, a sulfoxide-based solvent, a ketone-based solvent, an ether-based solvent, an ester-based solvent, and an aromatic hydrocarbon-based solvent. Examples of a dispersion method for dispersing the conductive particles in the coating liquid for a conductive layer include methods using a paint shaker, a sand mill, a ball mill, and a liquid collision-type high-speed disperser.

The conductive layer has an average thickness of preferably 1 μm or more and 50 μm or less, particularly preferably 3 μm or more and 40 μm or less.

### <Undercoat Layer>

In the present disclosure, an undercoat layer may be arranged on the support or the conductive layer. The arrangement of the undercoat layer can improve an adhesive function between layers to impart a charge injection-inhibiting function.

The undercoat layer preferably contains a resin. In addition, the undercoat layer may be formed as a cured film by polymerizing a composition containing a monomer having a polymerizable functional group.

Examples of the resin include a polyester resin, a polycarbonate resin, a polyvinyl acetal resin, an acrylic resin, an epoxy resin, a melamine resin, a polyurethane resin, a phenol resin, a polyvinyl phenol resin, an alkyd resin, a polyvinyl alcohol resin, a polyethylene oxide resin, a polypropylene oxide resin, a polyamide resin, a polyamic acid resin, a polyimide resin, a polyamide imide resin, and a cellulose resin.

Examples of the polymerizable functional group of the monomer having a polymerizable functional group include an isocyanate group, a blocked isocyanate group, a methylol group, an alkylated methylol group, an epoxy group, a metal alkoxide group, a hydroxy group, an amino group, a carboxy group, a thiol group, a carboxylic anhydride group, and a carbon-carbon double bond group.

In addition, the undercoat layer may further contain an electron-transporting substance, metal oxide particles, metal particles, a conductive polymer, and the like for the purpose of improving electrical characteristics. Of those, an electron-transporting substance and metal oxide particles are preferably used.

Examples of the electron-transporting substance include a quinone compound, an imide compound, a benzimidazole compound, a cyclopentadienylidene compound, a fluorenone compound, a xanthone compound, a benzophenone compound, a cyanovinyl compound, a halogenated aryl compound, a silole compound, and a boron-containing compound. An electron-transporting substance having a polymerizable functional group may be used as the electron-transporting substance and copolymerized with the above-mentioned monomer having a polymerizable functional group to form the undercoat layer as a cured film.

Examples of the metal oxide particles include particles of indium tin oxide, tin oxide, indium oxide, titanium oxide, strontium titanate, zinc oxide, and aluminum oxide. Particles of silicon dioxide may also be used. Examples of the metal particles include particles of gold, silver, and aluminum.

The metal oxide particles to be incorporated into the undercoat layer may be subjected to surface treatment with a surface treatment agent such as a silane coupling agent before use.

A general method is used as a method of subjecting the metal oxide particles to the surface treatment. Examples thereof include a dry method and a wet method.

The dry method involves, while stirring the metal oxide particles in a mixer capable of high-speed stirring such as a Henschel mixer, adding an alcohol aqueous solution, an organic solvent solution, or an aqueous solution containing the surface treatment agent, and uniformly dispersing the mixture, followed by drying.

In addition, the wet method involves stirring the metal oxide particles and the surface treatment agent in a solvent, or dispersing the metal oxide particles and the surface treatment agent in a solvent with, for example, a sand mill through use of glass beads or the like. After the dispersion, the solvent is removed by filtration or evaporation under reduced pressure. After the removal of the solvent, it is preferred that baking be further performed at 100° C. or more.

The undercoat layer may further contain additives, and for example, known materials may be incorporated into the undercoat layer. Examples of the known materials include metal particles such as aluminum particles, conductive particles such as carbon black, a charge-transporting substance, a metal chelate compound, and an organometallic compound.

The undercoat layer may be formed by: preparing a coating liquid for an undercoat layer containing each of the above-mentioned materials and a solvent; forming a coat thereof on the support or the conductive layer; and drying and/or curing the coat.

Examples of the solvent to be used in the coating liquid for an undercoat layer include organic solvents, such as an alcohol, a sulfoxide, a ketone, an ether, an ester, an aliphatic halogenated hydrocarbon, and an aromatic compound. In the present disclosure, an alcohol-based solvent or a ketone-based solvent is preferably used.

Examples of a dispersion method for preparing the coating liquid for an undercoat layer include methods using a homogenizer, an ultrasonic disperser, a ball mill, a sand mill, a roll mill, a vibration mill, an attritor, and a liquid collision-type high-speed disperser.

The average thickness of the undercoat layer is preferably 0.1 μm or more and 50 μm or less, more preferably 0.2 μm or more and 40 μm or less, particularly preferably 0.3 μm or more and 30 μm or less.

### <Surface Layer>

The surface layer of the electrophotographic photosensitive member of the present invention is a photosensitive layer containing a binder resin, a charge-generating substance, a hole-transporting substance, an electron-transporting substance, and silicon atom-containing particles.

The charge-generating substance to be incorporated into the surface layer is metal-free phthalocyanine or oxytitanium phthalocyanine. The metal-free phthalocyanine may be represented by the following formula (G-1). The oxytitanium phthalocyanine may be represented by the following formula (G-2).

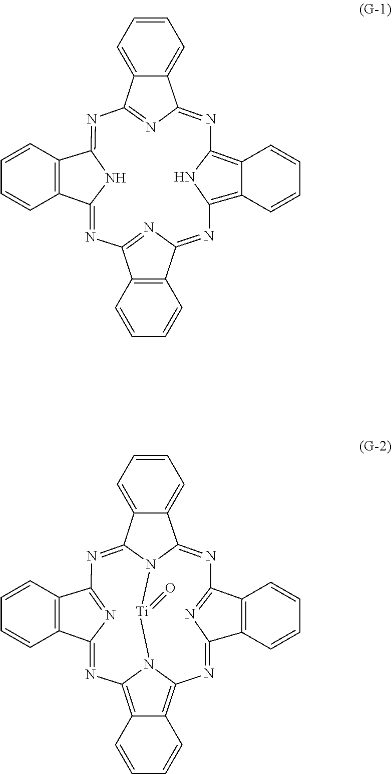

The content of the charge-generating substance is preferably 0.2 mass % or more and 10 mass % or less, more preferably 0.5 mass % or more and 2 mass % or less with respect to the total mass of the surface layer.

The silicon atom-containing particles to be incorporated into the surface layer are silica particles or silicone resin particles.

Commercially available silica particles that may be used in the present disclosure are, for example, silica particles manufactured by Nippon Aerosil Co., Ltd., such as AEROSIL RX200, AEROSIL RX300, AEROSIL RY200, AEROSIL R974, and AEROSIL NAX50.

Commercially available silicone resin particles that may be used in the present disclosure are, for example, silicone resin particles manufactured by Shin-Etsu Chemical Co., Ltd., such as X-52-854, X-52-1621, and KMP-590, and silicone resin particles manufactured by Nikko Rica Corporation, such as MSP-N050 and MSP-N080.

The content of the silicon atom-containing particles in the surface layer is preferably 0.1 mass % or more and 10.0 mass % or less with respect to the total mass of the surface layer from the viewpoint of satisfying both the suppression of a pattern memory and the suppression of repeated potential fluctuation. When the content is less than 0.1 mass %, the pattern memory may be aggravated. When the content is more than 10.0 mass %, the repeated potential fluctuation may be aggravated.

The content of the silicon atom-containing particles in the surface layer is preferably 10 mass % or more and 1,400 mass % or less with respect to the content of the charge-generating substance in the surface layer from the viewpoint of satisfying both the suppression of a pattern memory and the suppression of repeated potential fluctuation. When the content is less than 10 mass %, the pattern memory may be aggravated. When the content is more than 1,400 mass %, the repeated potential fluctuation may be aggravated.

The number-average primary particle diameter of the silicon atom-containing particles to be incorporated into the surface layer is determined from the cross-section of the surface layer. Specifically, 50 silicon atom-containing particles in the cross-section of the surface layer are observed, and an image is obtained. Each longest diameter is determined by subjecting the image to ellipse fitting. An average of the 10 longest diameters from longest among the determined longest diameters is defined as the number-average primary particle diameter of the silicon atom-containing particles.

The number-average primary particle diameter of the silicon atom-containing particles to be incorporated into the surface layer is preferably 10 nm or more and 2,000 nm or less from the viewpoint of satisfying both the suppression of a pattern memory and the suppression of repeated potential fluctuation. When the number-average primary particle diameter is less than 10 nm, the pattern memory may be aggravated. When the number-average primary particle diameter is more than 2,000 nm, the repeated potential fluctuation may be aggravated.

Examples of the binder resin include a polycarbonate resin, a polyarylate resin, an acrylic resin, and a polystyrene resin. Of those, a thermoplastic resin is preferred, and a polycarbonate resin or a polyarylate resin is particularly preferred.

Examples of the hole-transporting substance include: oxadiazole derivatives such as 2,5-bis(p-diethylaminophenyl)-1,3,4-oxadiazole; pyrazoline derivatives, such as 1,3,5-triphenyl-pyrazoline and 1-[pyridyl-(2)]-3-(p-diethylaminostyryl)-5-(p-diethylaminostyryl) pyrazoline; aromatic tertiary amino compounds, such as triphenylamine, N,N′-bis(3,4-dimethylphenyl) biphenyl-4-amine, tri (p-methylphenyl) aminyl-4-amine, and dibenzylaniline; aromatic tertiary diamino compounds such as N,N′-bis(3-methylphenyl)-N,N′-diphenylbenzidine; 1,2,4-triazine derivatives such as 3-(4′-dimethylaminophenyl)-5,6-di-(4′-methoxyphenyl)-1,2,4-triazine; hydrazone derivatives such as 4-diethylaminobenzaldehyde-1,1-diphenylhydrazone; quinazoline derivatives such as 2-phenyl-4-styryl-quinazoline; benzofuran derivatives such as 6-hydroxy-2,3-di(p-methoxyphenyl)benzofuran; α-stilbene derivatives such as p-(2,2-diphenylvinyl)-N,N-diphenylaniline; enamine derivatives; carbazole derivatives such as N-ethylcarbazole; poly-N-vinylcarbazole and derivatives thereof; and polymers having groups formed of the above-mentioned compounds on main chains or side chains thereof. Those hole-transporting substances may be used alone or in combination thereof.

Examples of the electron-transporting substance include a quinone compound, a diimide compound, a hydrazone compound, a malononitrile-based compound, a thiopyran-based compound, a trinitrothioxanthone-based compound, a 3,4,5,7-tetranitro-9-fluorenone-based compound, a dinitroanthracene-based compound, a dinitroacridine-based compound, tetracyanoethylene, 2,4,8-trinitrothioxanthone, dinitrobenzene, dinitroacridine, succinic anhydride, maleic anhydride, and dibromomaleic anhydride. Examples of the quinone-based compound include a diphenoquinone-based compound, an azoquinone-based compound, an anthraquinone-based compound, a naphthoquinone-based compound, a nitroanthraquinone-based compound, and a dinitroanthraquinone-based compound. Those electron-transporting substances may be used alone or in combination thereof.

In addition, the surface layer may contain an additive, such as an antioxidant, a UV absorber, a plasticizer, a leveling agent, a slipperiness-imparting agent, and an abrasion resistance-improving agent. Specific examples thereof include a hindered phenol compound, a hindered amine compound, a biphenyl derivative, a terphenyl compound, a sulfur compound, a phosphorus compound, a benzophenone compound, a siloxane-modified resin, and a silicone oil.

The average thickness of the surface layer is preferably 5 μm or more and 50 μm or less, more preferably 8 μm or more and 40 μm or less, particularly preferably 10 μm or more and 35 μm or less.

The surface layer may be formed by: preparing a coating liquid for a surface layer containing each of the above-mentioned materials and a solvent; forming a coat thereof; and drying the coat. Examples of the solvent to be used in the coating liquid for a surface layer include an alcohol-based solvent, a sulfoxide-based solvent, a ketone-based solvent, an ether-based solvent, an ester-based solvent, and an aromatic hydrocarbon-based solvent.

### <Toner and Developer>

The toner to be used in the electrophotographic apparatus of the present disclosure is a toner including toner particles each containing a polyester resin having a polyethylene terephthalate segment.

The toner according to the present disclosure is described below.

<Polyester Resin having Polyethylene Terephthalate Segment>

Examples of a component for forming the polyester resin containing polyethylene terephthalate include a polyethylene terephthalate segment, dihydric or higher alcohol monomer components, and acid monomer components, such as divalent or higher carboxylic acids, divalent or higher carboxylic anhydrides, and divalent or higher carboxylic acid esters.

### <Polyethylene Terephthalate Segment>

The polyethylene terephthalate segment of the present disclosure has a structure in which (C₁₀H₈O₄), which is a structural unit of polyethylene terephthalate, is repeated.

As the polyethylene terephthalate segment of the present disclosure, a polyethylene terephthalate segment that is produced by a condensation reaction or a transesterification reaction between ethylene glycol and terephthalic acid, dimethyl terephthalate, or the like in accordance with an ordinary method may be used, and a recovered polyethylene terephthalate resin may also be used.

The polyethylene terephthalate resin is used in various products, such as a container and a film, and is preferably recovered to be reused from the viewpoint of environmental protection. The kind of the recovered polyethylene terephthalate resin is not limited as long as the resin has an appropriate level of purity without containing impurities that influence toner characteristics and reactions in the production process.

<Dihydric or higher Alcohol Monomer Component>

Examples of the dihydric or higher alcohol monomer component include: alkylene oxide adducts of bisphenol A, such as polyoxypropylene (2.2)-2,2-bis(4-hydroxyphenyl) propane, polyoxypropylene (3.3)-2,2-bis(4-hydroxyphenyl) propane, polyoxyethylene (2.0)-2,2-bis(4-hydroxyphenyl) propane, polyoxypropylene (2.0)-polyoxyethylene (2.0)-2,2-bis(4-hydroxyphenyl) propane, and polyoxypropylene (6)-2,2-bis(4-hydroxyphenyl) propane; and ethylene glycol, 1,2-propylene glycol, 1,4-butanediol, neopentyl glycol, polyethylene glycol, and polypropylene glycol.

### <Acid Monomer Component>

Meanwhile, examples of the acid monomer component, such as a divalent or higher carboxylic acid, a divalent or higher carboxylic acid anhydride, and a divalent or higher carboxylic acid ester, include: aromatic dicarboxylic acids, such as phthalic acid, isophthalic acid, and terephthalic acid, or anhydrides thereof; and alkyl dicarboxylic acids, such as oxalic acid, malonic acid, succinic acid, adipic acid, maleic acid, fumaric acid, citraconic acid, and itaconic acid, or anhydrides thereof.

<Production Method for Polyester Resin having Polyethylene Terephthalate Segment>

The polyester resin having a polyethylene terephthalate segment in the present disclosure may be produced in accordance with an ordinary polyester synthesis method. For example, a desired polyester resin may be obtained by subjecting a carboxylic acid monomer and an alcohol monomer to an esterification reaction or a transesterification reaction, and then subjecting the resultant to a polycondensation reaction in accordance with an ordinary method under reduced pressure or while introducing a nitrogen gas. Further, it is more preferred that such a toner as described below be used because low-temperature fixability and scratch resistance can be improved.

In the present disclosure, the following case is preferred: the toner is a toner including toner particles each containing a binder resin; the binder resin contains an amorphous resin A and a crystalline polyester C; the amorphous resin A is the polyester resin and has, as structures for forming a polyester backbone,
(i) the polyethylene terephthalate segment, and
(ii) at least one structure selected from the group consisting of units represented by the following formulae (1) to (4):

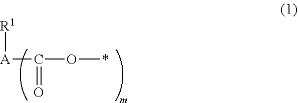

where R¹ represents an alkyl group having 6 to 16 carbon atoms or an alkenyl group having 6 to 16 carbon atoms, A represents a hydrocarbon group, “*” represents a bonding site in the polyester backbone, and “m” represents an integer of 2 or more;

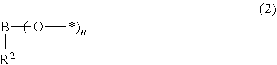

where R² represents an alkyl group having 6 to 16 carbon atoms or an alkenyl group having 6 to 16 carbon atoms, B represents a hydrocarbon group, “*” represents a bonding site in the polyester backbone, and “n” represents an integer of 2 or more;

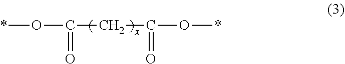

where “*” represents a bonding site in the polyester backbone, and “x” represents an integer of from 6 to 16;

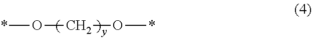

where “*” represents a bonding site in the polyester backbone, and “y” represents an integer of from 6 to 16;
when an SP value of the amorphous resin A is represented by SP_{A} (cal/cm³)^{0.5}, and an SP value of the crystalline polyester C is represented by SP_{C} (cal/cm³)^{0.5}, the SP_{A} and the SP_{C} satisfy the following formula (C):

1.00≤SP_{A}−SP_{C}≤1.35 (C);
the toner contains a phosphorus element derived from a phosphorus compound; and, when a content of the phosphorus element in the toner based on a mass of the toner is represented by W_{P} (ppm), the W_{P} satisfies the following formula (D):

5≤W_{P}≤500 (D).

A case in which the W_{P} satisfies the following formula (E) is more preferred:

20≤W_{P}≤500 (E).

The reason for the improvement of low-temperature fixability and scratch resistance is described below.

Investigations made by the inventors have found that the toner having such characteristics as described below improves scratch resistance while exhibiting satisfactory low-temperature fixability.
(i) A three-dimensional structure can be flexibly deformed in a direction in which external force is applied.
(ii) When the external force is removed, an original three-dimensional structure can be recovered.

Such toner can be achieved by the above-mentioned configuration.

The amorphous resin A has at least one structure selected from the group consisting of the units represented by the formulae (1) to (4), and the SP values of the amorphous resin A and the crystalline polyester C are controlled. As a result, the amorphous resin A has affinity for the crystalline polyester C. Thus, in a fixed image, the amorphous resin A is influenced by the crystalline polyester C to become flexible. In addition, this structure disperses the applied external force, and hence the three-dimensional structure can be flexibly deformed in the direction in which the external force is applied without a molecular chain being broken. In addition, the amorphous resin A contains the polyethylene terephthalate segment and hence has a repeating structure of a condensate of terephthalic acid and ethylene glycol in the polyester backbone. In the structure derived from the ethylene glycol of the polyethylene terephthalate segment, both terminals of the ethylene glycol are subjected to an esterification reaction, and hence the structure has ester groups at a significantly close molecular distance corresponding to two carbon atoms. Thus, the amorphous resin A has ester groups localized in the resin. In addition, the phosphorus compound in which three unshared electron pairs in the outermost shell are caused to react also has bonding points at a significantly close molecular distance. As a result, the amorphous resin A can interact with the ester groups localized in the amorphous resin A around phosphorus elements of the phosphorus compound, and thus can form a three-dimensional crosslinked structure. By virtue of the presence of this structure, when the applied external force is removed, the deformed state can be returned to the original three-dimensional structure. As described above, it is conceived that the configuration of the present disclosure enables excellent low-temperature fixability and scratch resistance to be obtained.

The amorphous resin A in the present disclosure has at least one structure selected from the group consisting of the units represented by the formulae (1) to (4) as the structure for forming the polyester backbone. The structure of the long-chain hydrocarbon group, such as an alkyl group or an alkenyl group, in each of the units represented by the formulae (1) to (4) becomes a structure having relatively low polarity as compared to the above-mentioned structure derived from the ethylene glycol of the polyethylene terephthalate segment. As a result, the structure of a long-chain hydrocarbon group, such as an alkyl group or an alkenyl group, in each of the units represented by the formulae (1) to (4) becomes flexible when the affinity for the crystalline polyester C is increased. In addition, this structure disperses the applied external force, and hence the three-dimensional structure can be flexibly deformed in the direction in which the external force is applied without a molecular chain being broken. As a result, the improvement of elastic deformation is achieved to provide excellent scratch resistance. In addition, the SP_{A} (cal/cm³)^{0.5} of the amorphous resin A and the SP_{C} (cal/cm³)^{0.5} of the crystalline polyester C in the present disclosure satisfy the formula (C). When SP_{A}-SP_{C} satisfies the formula (C), the amorphous resin A and the crystalline polyester C easily become compatible, and hence the crystalline polyester C can smoothly work on the structure of the amorphous resin A having the long-chain hydrocarbon group, such as an alkyl group or an alkenyl group. As a result, this structure becomes flexible when the affinity for the crystalline polyester C is increased. In addition, this structure disperses the applied external force, and hence the three-dimensional structure can be flexibly deformed in the direction in which the external force is applied without a molecular chain being broken. As a result, the improvement of an elastic deformation characteristic is achieved to provide excellent scratch resistance.

Further, the toner of the present disclosure contains phosphorus elements derived from the phosphorus compound, and the W_{P} (ppm) satisfies the formula (D). When the content of the phosphorus elements in the toner satisfies the formula (D), this case indicates that the phosphorus elements are present in an amount sufficient for an interaction with the ester groups localized in the amorphous resin A around the phosphorus elements to form a three-dimensional crosslinked structure. That is, the above-mentioned content corresponds to the minimum amount of the phosphorus elements in which the applied external force is dispersed, and hence the three-dimensional structure can be flexibly changed in the direction in which the external force is applied without breakage of the molecular chain, and the maximum amount of the phosphorus elements in which a certain degree of plastic deformation capable of ensuring low-temperature fixability can be ensured.

### <Amorphous Resin A>

The amorphous resin A is a polyester resin and has the following (i) and (ii) as structures for forming a polyester backbone:
(i) a polyethylene terephthalate segment; and
(ii) at least one structure selected from the group consisting of the units represented by the formulae (1) to (4).

The polyethylene terephthalate segment to be used in the amorphous resin A is obtained by subjecting ethylene glycol and terephthalic acid to polycondensation.

In addition, the synthesis of the polyester resin may be performed in an inert gas atmosphere, preferably in the presence of an esterification catalyst, and further as required, in the presence of an esterification promoter, a polymerization inhibitor, and the like, preferably at a temperature of 180° C. or more and 250° C. or less.

Examples of the esterification catalyst include a tin compound, such as dibutyltin oxide or tin (II) 2-ethylhexanoate, and a titanium compound such as titanium diisopropylate bistriethanolaminate. Of those, a tin compound such as tin (II) 2-ethylhexanoate is preferred. The usage amount of the esterification catalyst is preferably 0.01 part by mass or more, more preferably 0.1 part by mass or more, and preferably 1.5 parts by mass or less, more preferably 1.0 part by mass or less with respect to 100 parts by mass of the raw material monomers (an alcohol component, a carboxylic acid component, and PET). An example of the esterification promoter is gallic acid. The usage amount of the esterification promoter is preferably 0.001 part by mass or more, more preferably 0.01 part by mass or more and preferably 0.5 part by mass or less, more preferably 0.1 part by mass or less with respect to 100 parts by mass of the raw material monomers. An example of the polymerization inhibitor is tert-butyl catechol. The usage amount of the polymerization inhibitor is preferably 0.001 part by mass or more, more preferably 0.01 part by mass or more and preferably 0.5 part by mass or less, more preferably 0.1 part by mass or less with respect to 100 parts by mass of the raw material monomers.

In addition, in the synthesis of the polyester resin, the polyethylene terephthalate may be allowed to be present from the start of the polycondensation reaction, or may be added to the reaction system during the polycondensation reaction. In order for the polyethylene terephthalate segment to be incorporated into the main backbone of the polyester in a block form to a certain extent, the timing of the addition of the polyethylene terephthalate is preferably in a stage in which the reaction rate of the alcohol component and the carboxylic acid component is 10% or less, more preferably in a stage in which the reaction rate is 5% or less. Herein, the reaction rate refers to the value of generated reaction water amount (mol)/theoretical generated water amount (mol)×100.

In addition, spent polyethylene terephthalate (so-called regenerated PET) may be used as the polyethylene terephthalate segment to be incorporated into the amorphous resin A. It is preferred that the polyethylene terephthalate be reused from the viewpoint of the environment.

The spent PET is recovered. The recovered PET is washed and sorted so as to be prevented from being mixed with other materials and dust. After a label and the like are removed, the resultant is pulverized into flakes or the like. The pulverized product may be used as it is, or the pulverized product, which is kneaded and coarsely pulverized, may also be used. When chemical substances adsorbed to the surface of a PET bottle cannot be sufficiently removed by ordinary washing, alkali washing may be performed. When part of the pulverized product is hydrolyzed by the alkali washing, it is preferred that the washed pulverized product, which is melted and pelletized, be subjected to solid phase polymerization in order to restore the reduced polymerization degree. A solid-phase polymerization step may be performed by subjecting the washed flakes or the flakes, which are melted and extruded into pellets, to continuous solid-phase polymerization in an inert gas, such as a nitrogen gas or a noble gas, at a temperature of from 180° C. to 245° C., preferably from 200° C. to 240° C. In addition, the washed pulverized product, which is decomposed to a monomer unit by depolymerization and resynthesized, may also be used. In addition, the regenerated PET is not limited to the above-mentioned spent PET, and fiber scraps or pellets of off-spec PET discharged from factories may also be used.

In addition, in order to incorporate at least one unit selected from the group consisting of the units represented by the formulae (1) to (4) into the amorphous resin A, the following monomers may be used. Examples thereof include 1,6-hexanediol, 1,7-heptanediol, 1,8-octanediol, 1,9-nonanediol, 1,10-decanediol, 1,11-undecanediol, 1,12-dodecanediol, suberic acid, azelaic acid, sebacic acid, undecanedioic acid, dodecanedioic acid, hexadecanedioic acid, octadecanedioic acid, dodecenylsuccinic acid, n-octylsuccinic acid, isododecenylsuccinic acid, dodecylsuccinic acid, isooctenylsuccinic acid, and hexadecylsuccinic acid.

Of the units represented by the formulae (1) to (4), the units represented by the formula (1) and the formula (2) are preferred. The alkyl group or alkenyl group having 6 to 16 carbon atoms is branched from the main chain of the polyester backbone. Thus, the affinity for a release agent is enhanced, and the dispersibility of the release agent is further enhanced.

In addition, as components for obtaining the amorphous resin A, other polyhydric alcohols (dihydric or higher alcohols), polyvalent carboxylic acids (divalent or higher carboxylic acids), and acid anhydrides or lower alkyl esters thereof may be used in addition to the above-mentioned structures and monomers.

The following polyhydric alcohol monomers may each be used as a polyhydric alcohol monomer. As a dihydric alcohol component, there are given, for example: ethylene glycol, propylene glycol, 1,3-butanediol, 1,4-butanediol, 2,3-butanediol, diethylene glycol, triethylene glycol, neopentyl glycol, 2-ethyl-1,3-hexanediol, hydrogenated bisphenol A, and a bisphenol represented by the formula (I) and derivatives thereof:

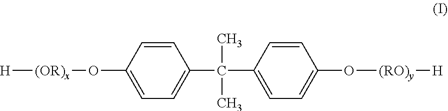

where R represents an ethylene or propylene group, “x” and “y” each represent an integer of 0 or more, and the average of x+y is 0 or more and 10 or less;
and diols each represented by the formula (J):

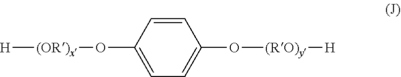

where R′ represents —CH₂CH₂—, —CH₂CH(CH₃)—, or —CH₂C(CH₃)₂—, x′ and y′ each represent an integer of 0 or more, and the average of x′+y′ is from 0 to 10.

As a trihydric or higher alcohol component, there are given, for example, sorbitol, 1,2,3,6-hexanetetrol, 1,4-sorbitan, pentaerythritol, dipentaerythritol, tripentaerythritol, 1,2,4-butanetriol, 1,2,5-pentanetriol, glycerol, 2-methylpropanetriol, 2-methyl-1,2,4-butanetriol, trimethylolethane, trimethylolpropane, and 1,3,5-trihydroxymethylbenzene. Of those, glycerol, trimethylolpropane, and pentaerythritol are preferably used.

Those dihydric alcohols and trihydric or higher alcohols may be used alone or in combination thereof.

As a divalent carboxylic acid component, there are given, for example, maleic acid, fumaric acid, citraconic acid, itaconic acid, glutaconic acid, phthalic acid, isophthalic acid, terephthalic acid, succinic acid, azelaic acid, malonic acid, anhydrides of those acids, and lower alkyl esters thereof. Of those, maleic acid, fumaric acid, and terephthalic acid are preferably used.

As a trivalent or higher carboxylic acid, an acid anhydride thereof, or a lower alkyl ester thereof, there are given, for example, 1,2,4-benzenetricarboxylic acid, 2,5,7-naphthalenetricarboxylic acid, 1,2,4-naphthalenetricarboxylic acid, 1,2,4-butanetricarboxylic acid, 1,2,5-hexanetricarboxylic acid, 1,3-dicarboxyl-2-methyl-2-methylenecarboxypropane, 1,2,4-cyclohexanetricarboxylic acid, tetra(methylenecarboxyl) methane, 1,2,7,8-octanetetracarboxylic acid, pyromellitic acid, EMPOL trimer acid, and acid anhydrides thereof or lower alkyl esters thereof. Of those, 1,2,4-benzenetricarboxylic acid, that is, trimellitic acid or a derivative thereof is particularly preferably used because trimellitic acid or the derivative thereof is available at low cost and its reaction can be easily controlled. Those divalent carboxylic acids and trivalent or higher carboxylic acids may be used alone or in combination thereof.

A method of producing the amorphous resin A is not particularly limited, and a known method may be used. For example, the polyester resin is produced by simultaneously loading the above-mentioned alcohol monomer and carboxylic acid monomer and polymerizing the mixture through an esterification reaction or a transesterification reaction and a condensation reaction. In addition, a polymerization temperature is not particularly limited, but preferably falls within the range of 180° C. or more and 290° C. or less. In the polymerization of a polyester unit, a polymerization catalyst, such as a titanium-based catalyst, a tin-based catalyst, zinc acetate, antimony trioxide, or germanium dioxide, may be used. In particular, the amorphous resin A is more preferably a polyester resin polymerized through use of a tin-based catalyst.

The amorphous resin A may be a polyester resin having a vinyl-based resin portion. A method of obtaining a polyester resin having a vinyl-based resin bonded thereto is preferably a method involving using a monomer component that may react with both the vinyl-based resin and the polyester unit. Such monomer is preferably a monomer having an unsaturated double bond and a carboxy group or a hydroxy group. Examples thereof include unsaturated dicarboxylic acids, such as phthalic acid, maleic acid, citraconic acid, and itaconic acid, or anhydrides thereof, and acrylic acid or methacrylic acid esters.

In addition, the peak molecular weight of the amorphous resin A is preferably 3,500 or more and 20,000 or less from the viewpoint of, for example, low-temperature fixability. The glass transition temperature of the resin is preferably from 40° C. to 70° C.

In addition, as an amorphous resin, various resins that have hitherto been known as binder resins may each be used in combination with the amorphous resin A. Examples of such resin include a phenol resin, a natural resin-modified phenol resin, a natural resin-modified maleic resin, an acrylic resin, a methacrylic resin, a polyvinyl acetate resin, a silicone resin, a polyester resin, a polyurethane resin, a polyamide resin, a furan resin, an epoxy resin, a xylene resin, a polyvinyl butyral resin, a terpene resin, a coumarone-indene resin, and a petroleum-based resin.

### <Crystalline Polyester C>

A polyhydric alcohol (dihydric or trihydric or higher alcohol), and a polyvalent carboxylic acid (divalent or trivalent or higher carboxylic acid), an acid anhydride thereof, or a lower alkyl ester thereof are used as monomers to be used for the polyester unit of the crystalline polyester C to be used in the toner of the present disclosure.

The following polyhydric alcohol monomers may each be used as a polyhydric alcohol monomer to be used for the polyester unit of the crystalline polyester C.

The polyhydric alcohol monomer is not particularly limited, but is preferably a chain (more preferably straight-chain) aliphatic diol. Examples thereof include ethylene glycol, diethylene glycol, triethylene glycol, 1,2-propylene glycol, 1,3-propylene glycol, dipropylene glycol, 1,6-hexanediol, 1,4-butanediol, 1,4-butadiene glycol, trimethylene glycol, tetramethylene glycol, pentamethylene glycol, hexamethylene glycol, octamethylene glycol, nonamethylene glycol, decamethylene glycol, and neopentyl glycol. Of those, straight-chain aliphatic α,ω-diols, such as ethylene glycol, diethylene glycol, 1,4-butanediol, and 1,6-hexanediol, are particularly preferred examples.

In the present disclosure, a polyhydric alcohol monomer except the above-mentioned polyhydric alcohols may also be used. Examples of a dihydric alcohol monomer out of the polyhydric alcohol monomers include: an aromatic alcohol, such as polyoxyethylenated bisphenol A or polyoxypropylenated bisphenol A; and 1,4-cyclohexanedimethanol. In addition, examples of a trihydric or higher polyhydric alcohol monomer out of the polyhydric alcohol monomers include: an aromatic alcohol such as 1,3,5-trihydroxymethylbenzene; and an aliphatic alcohol, such as pentaerythritol, dipentaerythritol, tripentaerythritol, 1,2,4-butanetriol, 1,2,5-pentanetriol, glycerin, 2-methylpropanetriol, 2-methyl-1,2,4-butanetriol, trimethylolethane, or trimethylolpropane.

The following polyvalent carboxylic acid monomers may each be used as a polyvalent carboxylic acid monomer to be used for the polyester unit of the crystalline polyester C.

The polyvalent carboxylic acid monomer is not particularly limited, but is preferably a chain (more preferably straight-chain) aliphatic dicarboxylic acid. Specific examples thereof include: oxalic acid, malonic acid, succinic acid, glutaric acid, adipic acid, pimelic acid, suberic acid, glutaconic acid, azelaic acid, sebacic acid, nonanedicarboxylic acid, decanedicarboxylic acid, undecanedicarboxylic acid, dodecanedicarboxylic acid, maleic acid, fumaric acid, mesaconic acid, citraconic acid, and itaconic acid; and products obtained by hydrolyzing acid anhydrides or lower alkyl esters thereof.

In the present disclosure, a polyvalent carboxylic acid except the above-mentioned polyvalent carboxylic acid monomers may also be used. Examples of a divalent carboxylic acid out of the other polyvalent carboxylic acid monomers include: an aromatic carboxylic acid, such as isophthalic acid or terephthalic acid; an aliphatic carboxylic acid, such as n-dodecylsuccinic acid or n-dodecenylsuccinic acid; an alicyclic carboxylic acid such as cyclohexanedicarboxylic acid; and acid anhydrides or lower alkyl esters thereof. In addition, examples of a trivalent or higher polyvalent carboxylic acid out of the other carboxylic acid monomers include: an aromatic carboxylic acid, such as 1,2,4-benzenetricarboxylic acid (trimellitic acid), 2,5,7-naphthalenetricarboxylic acid, 1,2,4-naphthalenetricarboxylic acid, or pyromellitic acid; an aliphatic carboxylic acid, such as 1,2,4-butanetricarboxylic acid, 1,2,5-hexanetricarboxylic acid, or 1,3-dicarboxy-2-methyl-2-methylenecarboxypropane; and derivatives, such as acid anhydrides or lower alkyl esters, thereof.

In addition, the crystalline polyester C is preferably a modified crystalline polyester having a structure in which a hydroxy group at a main chain terminal is terminally modified with an aliphatic monocarboxylic acid having 16 to 31 carbon atoms, or a modified crystalline polyester having a structure in which a carboxy group at a main chain terminal is terminally modified with an aliphatic monoalcohol having 15 to 30 carbon atoms.

Examples of the aliphatic monocarboxylic acid monomer having 16 to 31 carbon atoms include palmitic acid (hexadecanoic acid), margaric acid (heptadecanoic acid), stearic acid (octadecanoic acid), nonadecylic acid, arachidic acid (icosanoic acid), henicosanoic acid, docosanoic acid, tetracosanoic acid, hexacosanoic acid, octacosanoic acid, and triacontanoic acid.

Examples of the aliphatic monoalcohol having 15 to 30 carbon atoms include cetyl alcohol, palmityl alcohol (hexadecanol), margaryl alcohol (heptadecanol), stearyl alcohol (octadecanol), nonadecanol, arachidyl alcohol (icosanol), heneicosanol, behenyl alcohol, lignoceryl alcohol, ceryl alcohol, 1-heptacosanol, montanyl alcohol, 1-nonacosanol, and myricyl alcohol.

The crystalline polyester C may be produced in accordance with an ordinary polyester synthesis method. For example, the crystalline polyester may be obtained by: subjecting the carboxylic acid monomer and alcohol monomer described above to an esterification reaction or a transesterification reaction; and then subjecting the resultant to a polycondensation reaction in accordance with an ordinary method under reduced pressure or while introducing a nitrogen gas. After that, a desired crystalline polyester is obtained by further adding the above-mentioned aliphatic compound and performing an esterification reaction.

The esterification or transesterification reaction may be performed with a general esterification catalyst or transesterification catalyst, such as sulfuric acid, titanium butoxide, dibutyltin oxide, manganese acetate, or magnesium acetate, as required.

In addition, the polycondensation reaction may be performed with a known catalyst, for example, an ordinary polymerization catalyst, such as titanium butoxide, dibutyltin oxide, tin acetate, zinc acetate, tin disulfide, antimony trioxide, or germanium dioxide. A polymerization temperature and a catalyst amount are not particularly limited, and may be appropriately determined.

In the esterification or transesterification reaction, or the polycondensation reaction, the following method may be used: all the monomers are collectively loaded in order to improve the strength of the crystalline polyester to be obtained. In addition, for example, the following method may be used: the divalent monomers are caused to react with each other first, and then a monomer that is trivalent or more is added to, and caused to react with, the resultant, in order to reduce the amount of a low-molecular weight component.

The melting point of the crystalline polyester C is preferably from 70° C. to 110° C., more preferably from 80° C. to 100° C. from the viewpoint of low-temperature fixability. In the toner of the present disclosure, it is preferred that the crystalline polyester C be used in an amount of from 3 parts by mass or more and 20 parts by mass or less with respect to 100 parts by mass of the amorphous resin from the viewpoints of low-temperature fixability, scratch resistance, and a chargeability maintaining property under a high-temperature and high-humidity environment.

### <Phosphorus Compound>

Examples of the phosphorus compound to be used for the toner of the present disclosure include trisodium phosphate, trimethyl phosphate, triethyl phosphate, tri-2-ethylhexyl phosphate, tris(isopropylphenyl) phosphate, triphenyl phosphate, tributyl phosphate, trimethyl phosphite, tributyl phosphite, and triphenyl phosphite. Of those, a trivalent phosphorus compound that easily forms a three-dimensional crosslink is preferred.

The content W_{P} of the phosphorus element is as described above. Further, in order to form a three-dimensional crosslinked structure, spent polyethylene terephthalate (so-called regenerated PET) is preferably used because the block of polyethylene terephthalate is easily formed, and hence the ester groups at a close molecular distance can be more easily assembled to form a strong three-dimensional crosslinked structure. This structure can be returned to an original three-dimensional structure when the applied external force is removed.

### <Release Agent>

The toner particles may each contain a wax as a release agent. Examples of the wax include a polyethylene wax, a polypropylene wax, a polypropylene copolymer wax, a microcrystalline wax, a paraffin wax, a Fischer-Tropsch wax, a carnauba wax, a rice wax, a candelilla wax, and a montan wax.

### <Colorant>

The toner may contain a colorant. Examples of the colorant include known organic pigments or oil-based dyes, and magnetic materials. Examples of the colorant include carbon black, Phthalocyanine Blue, Permanent Brown FG, Brilliant Fast Scarlet, Pigment Red 122, Pigment Green B, Rhodamine-B base, Solvent Red 49, Solvent Red 146, Solvent Blue 35, quinacridone, Carmine 6B, isoindoline, Disazo Yellow, Benzidine Yellow, a monoazo-based dye or pigment, and a disazo-based dye or pigment.

### <Charge Control Agent>

The toner particles may each contain a charge control agent as required. A known charge control agent may be used as the charge control agent, but a positive charge control agent is preferably used, in particular, when combined with the photosensitive member used in the present disclosure.

Examples of the positive charge control agent include a quaternary ammonium salt compound, a triphenylmethane compound, an imidazole compound, and a nigrosine dye.

As a negative charge control agent, there are given, for example: a salicylic acid metal compound; a naphthoic acid metal compound; a dicarboxylic acid metal compound; a polymer-type compound having a sulfonic acid or a carboxylic acid in a side chain thereof; a polymer-type compound having a sulfonate or a sulfonic acid esterified product in a side chain thereof; a polymer-type compound having a carboxylate or a carboxylic acid esterified product in a side chain thereof; a boron compound; a urea compound; a silicon compound; and a calixarene.

### <Inorganic Fine Particles>

The toner may contain inorganic fine particles as required.

The inorganic fine particles may be internally added to the toner particles or may be mixed with the toner particles as an external additive. Examples of the inorganic fine particles include fine particles, such as silica fine particles, titanium oxide fine particles, alumina fine particles, and double oxide fine particles thereof. Of the inorganic fine particles, silica fine particles and titanium oxide fine particles are preferred from the viewpoints of improving fluidity and uniformizing charge. It is preferred that the inorganic fine particles be hydrophobized with a hydrophobizing agent, such as a silane compound, a silicone oil, or a mixture thereof.

### <External Additive>

In addition to the above-mentioned inorganic fine particles, organic fine particles, such as melamine-based resin fine particles and polytetrafluoroethylene resin fine particles, may be used as the external additive.

From the viewpoint of improving fluidity, the number-based median diameter (D50) of the external additive is preferably 10 nm or more and preferably 250 nm or less, more preferably 200 nm or less, still more preferably 90 nm or less.

The content of the external additive is preferably from 0.1 part by mass to 10.0 parts by mass with respect to 100 parts by mass of the toner particles. A known mixer such as a Henschel mixer may be used in the mixing of the toner particles and the external additive.

### <Developer>

The toner may be used as a one-component developer, but is preferably used as a two-component developer by being be mixed with a magnetic carrier in order to further improve dot reproducibility and to provide stable images over a long period of time. For example, generally known magnetic carriers including particles of metals, such as iron, cobalt, and nickel, and a magnetic material such as ferrite may each be used as the magnetic carrier.

### <Method of Producing Toner Particles>

A method of producing the toner particles is not particularly limited, and known methods, such as a pulverization method, a suspension polymerization method, a dissolution suspension method, an emulsion aggregation method, and a dispersion polymerization method, may be used. Of those, a pulverization method is preferred from the viewpoint of controlling a wax on the surface of each of the toner particles. That is, the toner particles are preferably pulverized toner particles. A toner production procedure in the pulverization method is described below.

The pulverization method includes, for example: a raw material-mixing step of mixing the crystalline polyester C and the amorphous resin A serving as the binder resin, the phosphorus compound, and other components, such as other amorphous resins, a wax, a colorant, and a charge control agent, as required; a step of melt-kneading the mixed raw materials to provide a resin composition; and a step of pulverizing the resultant resin composition to provide toner particles.

In the raw material-mixing step, predetermined amounts of, for example, the binder resin, the wax, and as required, other components, such as the colorant and the charge control agent, are weighed, and blended and mixed as materials for forming the toner particles. An example of a mixing apparatus is a double cone mixer, a V-type mixer, a drum-type mixer, a super mixer, a Henschel mixer, a Nauta mixer, or MECHANO HYBRID (manufactured by Nippon Coke & Engineering Co., Ltd.).

Next, the mixed materials are melt-kneaded so that the materials are dispersed in the binder resin. In the melt-kneading step, a batch-type kneader, such as a pressure kneader or a Banbury mixer, or a continuous kneader may be used, and a single-screw or twin-screw extruder has been in the mainstream because of the following superiority: the extruder can perform continuous production. Examples thereof include a KTK-type twin-screw extruder (manufactured by Kobe Steel, Ltd.), a TEM-type twin-screw extruder (manufactured by Toshiba Machine Co., Ltd.), a PCM kneader (manufactured by Ikegai Ironworks Corp.), a twin-screw extruder (manufactured by K.C.K.), a co-kneader (manufactured by Buss), and KNEADEX (manufactured by Nippon Coke & Engineering Co., Ltd.). Further, the resin composition obtained by the melt-kneading may be rolled with a twin-roll mill or the like, and may be cooled with water or the like in a cooling step.

Next, the cooled product of the resin composition is pulverized into a desired particle diameter in the pulverizing step. In the pulverizing step, the cooled product is first coarsely pulverized with a pulverizer, such as a crusher, a hammer mill, or a feather mill. Then, the cooled product is finely pulverized with, for example, KRYPTRON SYSTEM (manufactured by Kawasaki Heavy Industries, Ltd.), SUPER ROTOR (manufactured by Nisshin Engineering Inc.), TURBO MILL (manufactured by Turbo Kogyo Co., Ltd.), or a fine pulverizer based on an air jet system.

After that, as required, the finely pulverized product is classified with a classifier or a sifter, such as: ELBOW-JET (manufactured by Nittetsu Mining Co., Ltd.) based on an inertial classification system, or TURBOPLEX (manufactured by Hosokawa Micron Corporation), TSP SEPARATOR (manufactured by Hosokawa Micron Corporation), or FACULTY (manufactured by Hosokawa Micron Corporation) based on a centrifugal force classification system.

After that, the surfaces of the toner particles are subjected to external addition treatment with an external additive such as silica fine particles as required to provide a toner. As an apparatus for performing the external addition treatment, there is given a mixing apparatus, such as a double cone mixer, a V-type mixer, a drum-type mixer, a super mixer, a Henschel mixer, a Nauta mixer, MECHANO HYBRID (manufactured by Nippon Coke & Engineering Co., Ltd.), or NOBILTA (manufactured by Hosokawa Micron Corporation).

Methods of measuring various physical properties are described below.

(Method of Separating Each Material from Toner)

Each of the materials in the toner may be separated from the toner through utilization of differences between the solubilities of the materials in solvents and GPC. The following various physical properties may be measured through use of each separated material.

First separation: The toner is dissolved in methyl ethyl ketone (MEK) at 23° C. to be separated into soluble matter (the amorphous resin A, an amorphous resin B (used in Examples; the same applies hereinafter), the crystalline polyester C, and the phosphorus compound) and insoluble matter (the wax, the colorant, the inorganic fine particles, and the like).

Second separation: The soluble matter (the amorphous resin A, the amorphous resin B, the crystalline polyester C, and the phosphorus compound) obtained in the first separation is dissolved in tetrahydrofuran (THF) at 23° C. to be separated into soluble matter (the amorphous resin A, the amorphous resin B, and the phosphorus compound) and insoluble matter (the crystalline polyester C).

Third separation: The insoluble matter (the wax, the colorant, the inorganic fine particles, and the like) obtained in the first separation is dissolved in MEK at 100° C. to be separated into soluble matter (the wax) and insoluble matter (the colorant, the inorganic fine particles, and the like).

Fourth separation: The soluble matter (the amorphous resin A, the amorphous resin B, and the phosphorus compound) obtained in the second separation is dissolved in tetrahydrofuran (THF) at 23° C. to be separated into the amorphous resin A, the amorphous resin B, and the phosphorus compound by preparative GPC.

### <Identification of Attribution of Various Monomer Units in Amorphous Resin and Crystalline Polyester, and Measurement Method for Content Ratios Thereof>

The identification of attribution of various monomer units in the amorphous resin and the crystalline polyester and the measurement of the content ratios thereof are performed under the following conditions by 1H-NMR.
Measuring apparatus: FT NMR apparatus JNM-EX400 (manufactured by JEOL Ltd.)
Measurement frequency: 400 MHZ
Pulse condition: 5.0 μs
Frequency range: 10,500 Hz
Number of scans: 64 times
Measurement temperature: 30° C.
Sample: 50 mg of a measurement sample is loaded into a sample tube having an inner diameter of 5 mm, and deuterated chloroform (CDCl₃) is added as a solvent to the tube. The sample is dissolved in the solvent in a thermostat at 40° C. to prepare a solution.

From the resultant 1H-NMR chart, the structures of various monomer units are identified, and integrated values S₁, S₂, S₃, . . . Sₙ of peaks attributed to the respective monomer units are calculated.

The content ratio of each of the various monomer units is determined by using the integrated values S₁, S₂, S₃, . . . Sₙ as described below. n₁, n₂, n₃, . . . nₙ represent the numbers of hydrogen atoms in the respective monomer units.

Content ratio of each of various monomer units

$$( mol \% ) = \{ ( {S}_{n} / {n}_{n} ) / ( ( {S}_{1} / {n}_{1} ) + ( {S}_{2} / {n}_{2} ) + ( {S}_{3} / {n}_{3} ) … + ( {S}_{n} / {n}_{n} ) ) \} \times 100$$

The content ratio of each of the various monomer units (mol %) is calculated by changing the numerator term in the same operation. When such a polymerizable monomer that each of the various monomer units is free of any hydrogen atom is used, the measurement is performed by using ¹³C-NMR through use of ¹³C as a measurement atomic nucleus in a single-pulse mode, and the calculation is performed in the same manner as in ¹H-NMR.

### <Method of Calculating SP Values of Amorphous Resin and Crystalline Polyester>

The SP value of each of the amorphous resin and the crystalline polyester is calculated in accordance with a calculation method proposed by Fedors.

Specifically, the evaporation energy (Δei), molar volume (Δvi), and molar ratio (j) in the resin of each monomer unit are determined. The SP value is calculated through use of the determined values from the following equation.

$$SP value {( cal / {cm}^{3} )}^{0.5} = {\{ ( \sum j \times \sum Δ ei ) / ( \sum j \times \sum Δ vi ) \}}^{0.5}$$

Regarding the evaporation energy (Δei) and molar volume (Δvi) of an atom or an atomic group in the monomer unit, values described in “Polym. Eng. Sci., 14(2), 147-154 (1974)” are used.

<Method of measuring Content W_{P} of Phosphorus Elements in Toner>

The content W_{P} (ppm) of the phosphorus elements in the toner is measured with a multi-element simultaneous ICP emission spectrometer Vista-PRO (manufactured by Hitachi High-Tech Science Corporation).
Sample: 50 mg
Solvent: 6 mL of nitric acid

The above-mentioned materials were weighed and subjected to decomposition treatment with a microwave sample pretreatment device ETHOS UP (manufactured by Milestone General K.K.).
Temperature: The temperature is increased from 20° C. to 230° C. and held at 230° C. for 30 minutes.

The decomposed solution is passed through filter paper (5C). After that, the decomposed solution is transferred to a 50 mL measuring flask and diluted to 50 mL with ultrapure water. The content of the phosphorus elements in the toner may be quantified by measuring the aqueous solution in the measuring flask with the multi-element simultaneous ICP emission spectrometer Vista-PRO under the following conditions. In the quantification of the content, a calibration curve is prepared through use of a standard sample of the elements to be quantified, and the content is calculated based on the calibration curve.
Condition: RF power 1.20 kW
Ar gas: Plasma flow 15.0 L/min
Auxiliary flow: 1.50 L/min
MFC: 1.50 L/min
Nebulizer flow: 0.90 L/min
Liquid feed pump speed: 15 rpm
Measurement repetition: 3 times
Measurement time: 1.0 s

### <Electrophotographic Apparatus>

The electrophotographic apparatus of the present disclosure is characterized by including the electrophotographic photosensitive member described above, a toner, a charging unit, an exposing unit, a developing unit, a transfer unit, a cleaning unit, and a fixing unit.

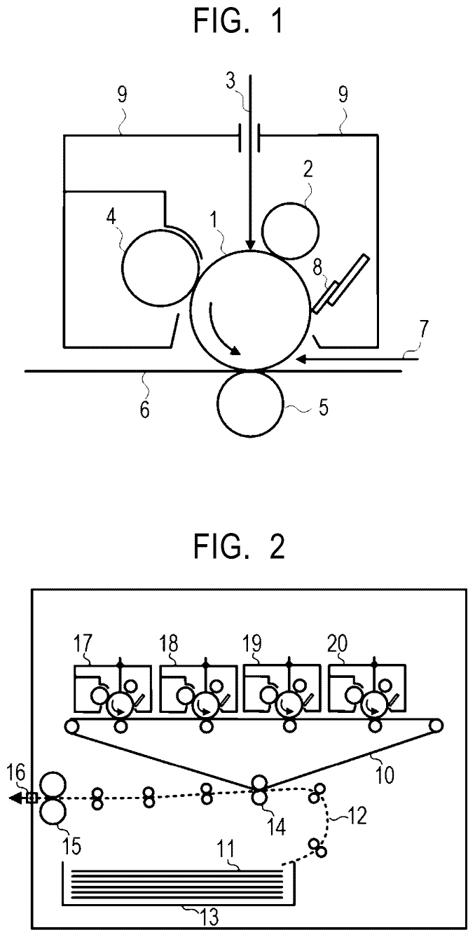

An example of the configuration of a process cartridge including the electrophotographic photosensitive member of the present disclosure is illustrated in FIG. 1, and an example of the schematic configuration of an electrophotographic apparatus including the process cartridge of FIG. 1 is illustrated in FIG. 2.

In FIG. 1, a cylindrical electrophotographic photosensitive member 1 is driven to rotate at a predetermined peripheral speed in a direction indicated by the arrow. The circumferential surface of the electrophotographic photosensitive member 1 that is driven to rotate is uniformly charged to a positive or negative predetermined potential by a charging unit 2. Then, the charged circumferential surface of the electrophotographic photosensitive member 1 receives image exposure light 3 emitted from an exposing unit (not shown), such as slit exposure light or laser beam scanning exposure light. Thus, an electrostatic latent image corresponding to an intended image is sequentially formed on the circumferential surface of the electrophotographic photosensitive member 1. Any one of a voltage in which an AC component is superimposed on a DC component or a voltage formed of only a DC component may be used as a voltage to be applied to the charging unit (e.g., a charging roller) 2.

The electrostatic latent image formed on the circumferential surface of the electrophotographic photosensitive member 1 is developed with a toner in a developer of a developing unit 4 to form a toner image. Then, the toner image formed and borne on the circumferential surface of the electrophotographic photosensitive member 1 is sequentially transferred onto a transfer material (e.g., paper or an intermediate transfer member) 6 with a transfer bias from a transfer unit (e.g., a transfer roller) 5. The transfer material 6 is fed in synchronization with the rotation of the electrophotographic photosensitive member 1.

The surface of the electrophotographic photosensitive member 1 after the transfer of the toner image is subjected to charge-eliminating treatment with pre-exposure light 7 from a pre-exposing unit (not shown). After that, the surface is cleaned by removal of a transfer residual toner (residual toner) with a cleaning unit 8 including a cleaning blade. Then, the electrophotographic photosensitive member 1 is repeatedly used for image formation. The treatment by the pre-exposing unit may be performed before or after a cleaning step, and the pre-exposing unit is not necessarily required.

The electrophotographic photosensitive member 1 may be mounted on an electrophotographic apparatus, such as a copying machine or a laser beam printer. In addition, a process cartridge 9 configured to integrally support a plurality of constituent elements, such as the electrophotographic photosensitive member 1, the charging unit 2, the developing unit 4, and the cleaning unit 8, accommodated in a container may be configured to be detachably attachable onto a main body of an electrophotographic apparatus. In FIG. 2, the electrophotographic photosensitive member 1, the charging unit 2, the developing unit 4, and the cleaning unit 8 are integrally supported to form the process cartridge 9 that is detachably attachable onto a main body of an electrophotographic apparatus.

Next, an electrophotographic apparatus including the electrophotographic photosensitive member of the present disclosure is described.

An example of the configuration of the electrophotographic apparatus of the present disclosure is illustrated in FIG. 2. A process cartridge 17 for yellow color, a process cartridge 18 for magenta color, a process cartridge 19 for cyan color, and a process cartridge 20 for black color, corresponding to yellow color, magenta color, cyan color, and black color, respectively, are arranged side by side along an intermediate transfer member 10. The diameter and constituent materials of the electrophotographic photosensitive member, a developer, a charging system, and other units are not necessarily required to be the same for each color.

When an image forming operation is started, a toner image of each color is sequentially superimposed on the intermediate transfer member 10 in accordance with the above-mentioned image forming process. In parallel, a transfer sheet 11 is sent from a sheet feeding tray 13 through a sheet feeding path 12 and fed to a secondary transfer unit 14 in synchronization with the timing of the rotation operation of the intermediate transfer member. A toner image on the intermediate transfer member 10 is transferred onto the transfer sheet 11 with a transfer bias from the secondary transfer unit 14. The toner image transferred onto the transfer sheet 11 is conveyed along the sheet feeding path 12 and fixed onto the transfer sheet by a fixing unit 15. Then, the transfer sheet 11 is delivered from a sheet delivery portion 16.

The electrophotographic photosensitive member of the present disclosure may be used in a laser beam printer, an LED printer, a copying machine, a facsimile, a multifunctional peripheral thereof, and the like.

According to the present disclosure, an electrophotographic apparatus in which a pattern memory is suppressed even under high temperature and high humidity can be provided.

### EXAMPLES

The present disclosure is described in more detail below by way of Examples and Comparative Examples. The present disclosure is not limited thereto. In the following description of Examples, the term “part(s)” is by mass unless otherwise stated.

### [Production Example of Electrophotographic Photosensitive Member 1]

2 Parts by mass of a polyamide resin (AMILAN CM8000, manufactured by Toray Industries, Inc.) was dissolved in a mixed solvent of 10 parts by mass of methyl ethyl ketone and 10 parts by mass of butanol.
5 Parts by mass of titanium oxide particles (product name: TKP-101, manufactured by Tayca Corporation, average primary particle diameter: 6 nm) coated with 10% of inorganic silica were added to the solution and dispersed with a sand mill device using glass beads each having a diameter of 0.8 mm under an atmosphere of 23±3° C. for 4 hours to prepare a coating liquid for an undercoat layer.

The resultant coating liquid for an undercoat layer was applied onto an aluminum cylinder having a diameter of 30 mm and a length of 357.5 mm serving as a support by dip coating to form a coat, and the resultant coat was dried at 130° C. for 30 minutes to form an undercoat layer having a thickness of 2.0 μm.

Next, a mixture containing 100 parts by mass of a polycarbonate resin represented by the following formula (C-1) serving as a binder resin, 70 parts by mass of a compound represented by the following formula (D-1) serving as a hole-transporting substance, 30 parts by mass of a compound represented by the following formula (E-1) and 10 parts by mass of a compound represented by the following formula (E-2) each serving as an electron-transporting substance, 2 parts by mass of a pigment represented by the following formula (G-1) serving as a charge-generating substance, 10 parts by mass of a compound represented by the following formula (F) serving as an additive, and 3 parts by mass of commercially available silica particles (number-average primary particle diameter: 12 nm, product name: AEROSIL RX200, manufactured by Nippon Aerosil Co., Ltd.) serving as silicon atom-containing particles was dispersed with a sand mill using glass beads each having a diameter of $1 mm for 8 hours to provide a dispersion liquid. The dispersion liquid was passed through a 100-mesh filter (opening: 0.254 mm) so that the glass beads were removed. Thus, a coating liquid for a surface layer was obtained. The coating liquid for a surface layer was applied onto the above-mentioned undercoat layer by dip coating, and the resultant coat was dried at 110° C. for 50 minutes to form a surface layer having a thickness of 30 μm.

An electrophotographic photosensitive member 1 was produced through the above-mentioned steps.

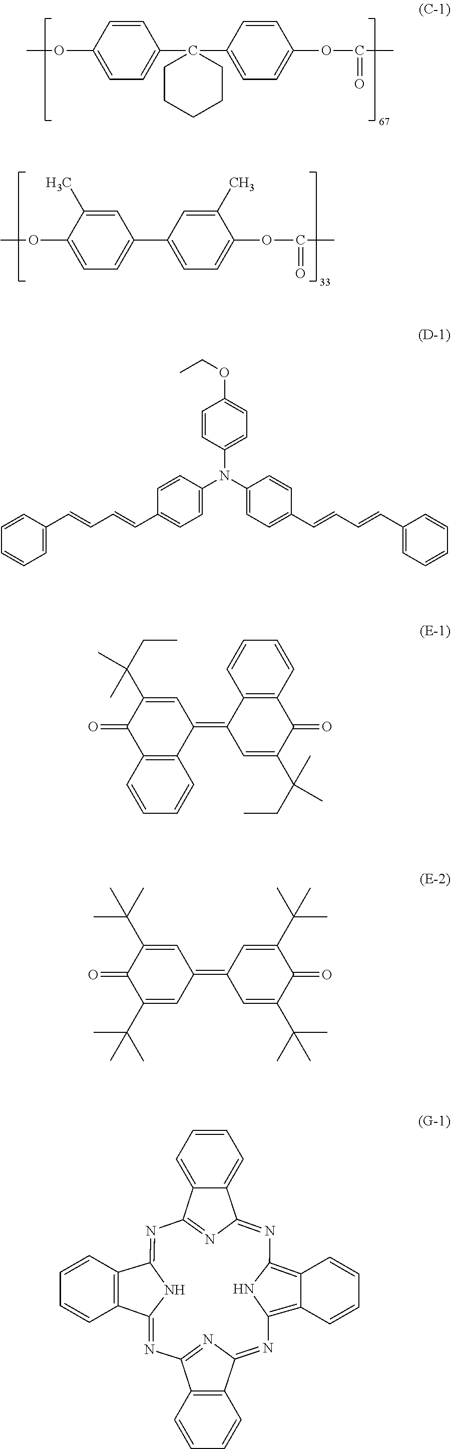

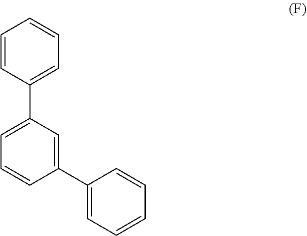 [SMILES: c1ccc(-c2cccc(-c3ccccc3)c2)cc1]

### [Production Examples of Electrophotographic Photosensitive Members 2 to 25]

The kinds of silicon atom-containing particles used in electrophotographic photosensitive members 2 to 25 are shown in Table 1.

TABLE 1

| Kind of silicon | | Number-average | | | |
|---|---|---|---|---|---|
| atom-containing | | primary particle | | | |
| particles | Material | diameter | | Product name | Manufacturer |
| H-1 | Silica | 12 | nm | AEROSIL | Nippon Aerosil |
| | | | | RX200 | Co., Ltd. |
| H-2 | Silica | 7 | nm | AEROSIL | Nippon Aerosil |
| | | | | RX300 | Co., Ltd. |
| H-3 | Silicone | 700 | nm | X-52-854 | Shin-Etsu |
| | resin | | | | Chemical Co., Ltd. |
| H-4 | Silicone | 2,000 | nm | KMP-590 | Shin-Etsu |
| | resin | | | | Chemical Co., Ltd. |
| H-5 | Silicone | 5,000 | nm | X-52-1621 | Shin-Etsu |

| | |
|---|---|
| resin | Chemical Co., Ltd. |

A charge-generating substance used in each of the electrophotographic photosensitive members 11, 23, and 25 is represented by the following formula (G-2).

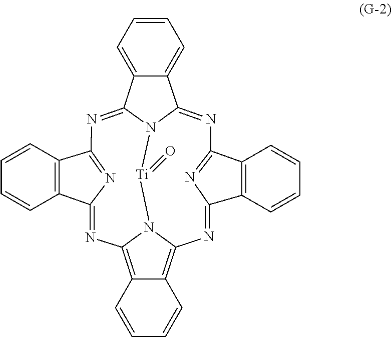

The electrophotographic photosensitive members were each produced in the same manner as in the production example of the electrophotographic photosensitive member 1 except that the kind and mass of the charge-generating substance and the kind and mass of the silicon atom-containing particles were changed as shown in Table 2 in the formation of the surface layer.

TABLE 2

| | | | Silicon atom-containing particles | | | |
|---|---|---|---|---|---|---|
| | | | | | Content with | Content with respect |
| | Charge-generating | | | | respect to total | to mass of charge- |
| | substance | | | | mass of surface | generating substance |
| | | Mass | | Mass | layer | in surface layer |
| | Kind | [part(s)] | Kind | [part(s)] | [mass %] | [mass %] |
| Electrophotographic | G-1 | 2 | H-1 | 3 | 1.3 | 150 |
| photosensitive member 1 | | | | | | |
| Electrophotographic | G-1 | 2 | H-1 | 0.2 | 0.1 | 10 |
| photosensitive member 2 | | | | | | |
| Electrophotographic | G-1 | 2 | H-1 | 0.23 | 0.1 | 11.5 |
| photosensitive member 3 | | | | | | |
| Electrophotographic | G-1 | 2 | H-1 | 24 | 9.8 | 1,200 |
| photosensitive member 4 | | | | | | |
| Electrophotographic | G-1 | 2 | H-1 | 28 | 11.2 | 1,400 |
| photosensitive member 5 | | | | | | |
| Electrophotographic | G-1 | 4 | H-1 | 0.23 | 0.1 | 6 |
| photosensitive member 6 | | | | | | |
| Electrophotographic | G-1 | 4 | H-1 | 3 | 1.3 | 75 |
| photosensitive member 7 | | | | | | |
| Electrophotographic | G-1 | 1 | H-1 | 28 | 11.2 | 2,800 |
| photosensitive member 8 | | | | | | |
| Electrophotographic | G-1 | 1 | H-1 | 3 | 1.3 | 300 |
| photosensitive member 9 | | | | | | |
| Electrophotographic | G-1 | 2 | H-2 | 3 | 1.3 | 150 |
| photosensitive member 10 | | | | | | |
| Electrophotographic | G-2 | 2 | H-1 | 3 | 1.3 | 150 |
| photosensitive member 11 | | | | | | |
| Electrophotographic | G-1 | 2 | H-3 | 6 | 2.6 | 300 |
| photosensitive member 12 | | | | | | |
| Electrophotographic | G-1 | 2 | H-3 | 0.2 | 0.1 | 10 |
| photosensitive member 13 | | | | | | |
| Electrophotographic | G-1 | 2 | H-3 | 0.23 | 0.1 | 12 |
| photosensitive member 14 | | | | | | |
| Electrophotographic | G-1 | 2 | H-3 | 24 | 9.8 | 1,200 |
| photosensitive member 15 | | | | | | |
| Electrophotographic | G-1 | 2 | H-3 | 28 | 11.2 | 1,400 |
| photosensitive member 16 | | | | | | |
| Electrophotographic | G-1 | 4 | H-3 | 0.23 | 0.1 | 6 |
| photosensitive member 17 | | | | | | |
| Electrophotographic | G-1 | 4 | H-3 | 6 | 2.6 | 150 |
| photosensitive member 18 | | | | | | |
| Electrophotographic | G-1 | 1 | H-3 | 28 | 11.2 | 2,800 |
| photosensitive member 19 | | | | | | |
| Electrophotographic | G-1 | 1 | H-3 | 6 | 2.6 | 600 |
| photosensitive member 20 | | | | | | |
| Electrophotographic | G-1 | 2 | H-4 | 6 | 2.6 | 300 |
| photosensitive member 21 | | | | | | |
| Electrophotographic | G-1 | 2 | H-5 | 6 | 2.6 | 300 |
| photosensitive member 22 | | | | | | |
| Electrophotographic | G-2 | 2 | H-3 | 6 | 2.6 | 300 |
| photosensitive member 23 | | | | | | |
| Electrophotographic | G-1 | 2 | None | 0 | 0.0 | 0 |
| photosensitive member 24 | | | | | | |
| Electrophotographic | G-2 | 2 | None | 0 | 0.0 | 0 |
| photosensitive member 25 | | | | | | |

### [Production Examples of Toner and Developer]

### <Measurement Method for Softening Point of Resin>

The softening point of a resin is measured with a constant-pressure extrusion system capillary rheometer (product name: flow characteristic-evaluating device Flowtester CFT-500D, manufactured by Shimadzu Corporation) in accordance with the manual attached to the apparatus. In this apparatus, a measurement sample filled in a cylinder is increased in temperature to be melted while a predetermined load is applied to the measurement sample with a piston from above, and the melted measurement sample is extruded from a die in a bottom part of the cylinder. At this time, a flow curve representing a relationship between a piston descent amount and a temperature can be obtained.

A “melting temperature in a ½ method” described in the manual attached to the “flow characteristic-evaluating device Flowtester CFT-500D” is adopted as the softening point. The melting temperature in the ½ method is calculated as described below. First, ½ of a difference between a descent amount (Smax) of the piston at a time when the outflow is finished and a descent amount (Smin) of the piston at a time when the outflow is started is determined (The ½ of the difference is represented by X. X=(Smax−Smin)/2). Then, the temperature when the descent amount of the piston reaches the sum of X and Smin in the flow curve is the melting temperature in the ½ method.

The measurement sample to be used is obtained by subjecting about 1.0 g of the resin to compression molding at about 10 MPa for about 60 seconds through use of a tablet compressing machine (e.g., NT-100H, manufactured by NPa SYSTEM Co., Ltd.) under an environment at 25° C. to form the sample into a columnar shape having a diameter of about 8 mm.

The measurement conditions of the CFT-500D are as described below.
Test mode: heating method
Starting temperature: 50° C.
Reached temperature: 200° C.
Measurement interval: 1.0° C.
Rate of temperature increase: 4.0° C./min
Piston sectional area: 1.000 cm²
Test load (piston load): 10.0 kgf/cm² (0.9807 MPa)
Preheating time: 300 seconds
Diameter of hole of die: 1.0 mm
Length of die: 1.0 mm

### <Production Example of Resin 1>

The following materials were loaded into a reaction vessel with a reflux condenser, a stirring machine, a temperature gauge, and a nitrogen-introducing tube under a nitrogen atmosphere.

| | | |
|---|---|---|
| Propylene oxide adduct of bisphenol A | 100 | parts by mass |
| (average number of moles added: 2.2 mol) | | |
| Recovered polyethylene terephthalate | 21 | parts by mass |
| (content of diethylene glycol = 1.3 mass %) | | |
| Dibutyltin oxide | 0.08 | part by mass |

A reaction was performed for 7 hours by heating the inside of the reaction vessel to 230° C. under stirring at 200 rpm. Subsequently, the mixture was cooled to 180° C., and 30 parts by mass of fumaric acid and 0.08 part by mass of hydroquinone were loaded into the reaction vessel, followed by heating to 210° C. over 4 hours. After that, the inside of the reaction vessel was reduced in pressure to 8 kPa, and the resultant was subjected to a reaction until the softening point of 103° C. was achieved. Thus, a resin 1 was obtained.

### <Production Example of Resin 2>

The following materials were loaded into a reaction vessel with a reflux condenser, a stirring machine, a temperature gauge, and a nitrogen-introducing tube under a nitrogen atmosphere.

| | |
|---|---|
| Propylene oxide adduct of bisphenol A | 100 parts by mass |
| (average number of moles added: 2.2 mol) | |
| Ethylene oxide adduct of bisphenol A | 40 parts by mass |
| (average number of moles added: 2.2 mol) | |
| Dodecenylsuccinic anhydride | 13 parts by mass |
| Terephthalic acid | 37 parts by mass |
| Trimellitic anhydride | 12 parts by mass |
| Dibutyltin oxide | 0.5 part by mass |

A reaction was performed for 4 hours by heating the inside of the reaction vessel to 235° C. under stirring at 200 rpm. After that, the inside of the reaction vessel was reduced in pressure to 8 kPa, and the resultant was subjected to a reaction until the softening point of 146° C. was achieved. Thus, a resin 2 was obtained.

### <Production Example of Toner Particles 1>

| | | |
|---|---|---|
| Resin 1 | 70 | parts by mass |
| Resin 2 | 30 | parts by mass |
| Carbon black R330R (manufactured by | 7 | parts by mass |
| Cabot Corporation) | | |
| Charge control agent BONTRON P-51 | 0.5 | part by mass |
| (manufactured by Orient Chemical | | |
| Industries Co., Ltd.) | | |
| Release agent Carnauba Wax No. 1 | 4 | parts by mass |
| (manufactured by S. Kato & Co.) | | |

The above-mentioned materials were mixed with a Henschel mixer (model FM-75, manufactured by Nippon Coke & Engineering Co., Ltd.) at a number of rotations of 20 s⁻¹ for a time of rotation of 5 min. After that, the mixture was kneaded with a twin-screw kneading machine set to a temperature of 120° C. and a number of rotations of a screw of 200 rpm (model PCM-30, manufactured by Ikegai Corp.) at a discharge temperature of 135° C. The kneaded product thus obtained was cooled at a cooling speed of 15° C./min and coarsely pulverized with a hammer mill to 1 mm or less to provide a coarsely pulverized product. The coarsely pulverized product thus obtained was finely pulverized with a mechanical pulverizer (T-250, manufactured by FREUND-Turbo Corporation). Further, the finely pulverized product was classified with Faculty F-300 (manufactured by Hosokawa Micron Corporation) to provide toner particles 1. Operating conditions were as follows: the number of rotations of a classification rotor was set to 130 s⁻¹ and the number of rotations of a dispersion rotor was set to 120 s⁻¹.

### [Production Example of Toner 1]

The following materials were mixed with a Henschel mixer (model FM-10C, manufactured by Nippon Coke & Engineering Co., Ltd.) at a number of rotations of 30 s⁻¹ for a time of rotation of 10 min to provide a toner 1.

| | | |
|---|---|---|
| Toner particles 1 | 100 | parts by mass |
| Silica fine particles subjected | 2.1 | parts by mass |
| to surface treatment with | | |
| hexamethyldisilazane having an | | |
| average particle diameter of 130 nm | | |
| Silica fine particles subjected | 0.7 | parts by mass |
| to surface treatment with | | |
| hexamethyldisilazane having an | | |
| average particle diameter of 20 nm | | |

<Production Example of Magnetic Carrier Core Particles 1>

| | | |
|---|---|---|
| Fe₂O₃ | 62.7 | parts by mass |
| MnCO₃ | 29.5 | parts by mass |
| Mg(OH)₂ | 6.8 | parts by mass |
| SrCO₃ | 1.0 | part by mass |

The above-mentioned materials were weighed as ferrite raw materials so as to have the above-mentioned composition ratio.

After that, the materials were pulverized and mixed with a dry vibration mill using stainless-steel beads for 5 hours. The pulverized product thus obtained was formed into about 1 mm square pellets with a roller compactor.

The pellets were sieved with a vibration sieve having an aperture of 3 mm so that coarse powder was removed, and were then sieved with a vibration sieve having an aperture of 0.5 mm so that fine powder was removed. After that, the resultant was calcined with a burner-type calcination furnace at a temperature of 1,000° C. for 4 hours under a nitrogen atmosphere (oxygen concentration: 0.01 vol %) to produce calcined ferrite.

The calcined ferrite was pulverized with a crusher to about 0.3 mm. After that, 30 parts by mass of water was added to 100 parts by mass of the calcined ferrite, and the resultant was pulverized with a wet ball mill for 1 hour through use of zirconia beads. Further, the slurry thus obtained was pulverized with a wet ball mill for 4 hours to provide a ferrite slurry (finely pulverized product of calcined ferrite).

1.0 Part by mass of ammonium polycarboxylate serving as a dispersant and 2.0 parts by mass of polyvinyl alcohol serving as a binder with respect to 100 parts by mass of the calcined ferrite were added to the ferrite slurry, and the mixture was granulated into spherical particles with a spray dryer (manufacturer: Ohkawara Kakohki Co., Ltd.). After the particle size of the particles thus obtained was adjusted, the resultant was heated at 650° C. for 2 hours with a rotary kiln so that organic components of the dispersant and the binder were removed.

In order to control the calcination atmosphere, the temperature was increased from room temperature to 1,300° C. in 2 hours in an electric furnace under a nitrogen atmosphere (oxygen concentration: 1.00 vol %), followed by calcination at a temperature of 1,150° C. for 4 hours. After that, the temperature was reduced to 60° C. over 4 hours, the atmosphere was returned from the nitrogen atmosphere to an atmospheric atmosphere, and the resultant was removed at a temperature of 40° C. or less.

After the aggregated particles were shredded, a low-magnetic force product was cut by magnetic separation, and the remainder was sieved with a sieve having an aperture of 250 μm so that coarse particles were removed. Thus, magnetic carrier core particles having a volume-based 50% particle diameter (D50) of 37.0 μm were obtained.

### <Production Example of Magnetic Carrier 1>

As a first coating step, a thermosetting silicone resin solution (methyl silicone resin) was applied to the magnetic carrier core particles. The amount of the resin for coating was set to 0.20 part by mass with respect to 100 parts by mass of the magnetic carrier core particles. In the application, a coating device, in which a rotary bottom plate disc and a stirring blade were installed in a fluidized bed so that coating was performed while a swirling flow was formed, was used. The above-mentioned resin solution was sprayed from a direction perpendicular to the movement direction of the fluidized bed in the device.

Next, the following materials were prepared.
Fluororesin solution (copolymer of tetrafluoroethylene and hexafluoropropylene (FEP)) (1.91 parts by mass with respect to 100 parts by mass of the magnetic carrier core particles in terms of solid content)
Thermosetting melamine resin solution (0.09 part by mass with respect to 100 parts by mass of the magnetic carrier core particles in terms of solid content)

Those materials were sufficiently stirred to be mixed to produce a carrier coating solution. The coating solution was applied to the magnetic carrier core particles as a second coating step. In the application, a coating device, in which a rotary bottom plate disc and a stirring blade were installed in a fluidized bed so that coating was performed while a swirling flow was formed, was used. After that, the carrier thus obtained was dried in the fluidized bed at a temperature of 280° C. for 1 hour so that a solvent was removed. Thus, a magnetic carrier 1 was obtained.

### [Production Example of Developer 1]

The following materials were mixed with a V-type mixer (V-20, manufactured by Seishin Enterprise Co., Ltd.) to provide a developer 1.

| | |
|---|---|
| Toner 1 | 8 parts by mass |
| Magnetic carrier 1 | 92 parts by mass |

### Example 1

An electrophotographic apparatus obtained by reconstructing an electrophotographic apparatus iR-ADV C5255 manufactured by Canon Inc. to a positive charging process and performing the following reconstruction was prepared as an electrophotographic apparatus.

The electrophotographic photosensitive member 1 was mounted to a black station of the prepared electrophotographic apparatus, and the developer 1 was set in a developing device as a developer.

### [Evaluation 1: Evaluation of Pattern Memory]

The above-mentioned electrophotographic apparatus was placed under an environment at 32.5° C./85% RH. The conditions of a charging device and an exposing device were set so that the charge potential of the electrophotographic photosensitive member was +600 V and the exposure potential thereof was +200 V, and the conditions of a developing device were set so that the developing potential was +400 V.

As a pattern image to be output, a pattern image including an image having a width of 10 mm and a length of 200 mm in a direction parallel to a sheet passing direction was prepared. Next, the pattern image was continuously output onto 5,000 sheets of A4-size plain paper as a solid image with a density of 100% in black monochromatic color. Subsequently, evaluation was made regarding whether or not a density difference had occurred in an image portion having a width of 10 mm and a length of 200 mm output previously when a full-screen halftone image having a density of 30% was output onto one sheet in black monochromatic color. The output image was evaluated based on the following evaluation criteria. The evaluation results are shown in Table 3.

### (Evaluation Criteria of Pattern Memory)

A: No density difference occurs.
B: A density difference occurs to the extent that whether or not the density difference is present cannot be determined.
C: A slight density difference occurs (acceptable level in the present invention).
D: A clear density difference occurs (unacceptable level in the present invention).

### [Evaluation 2: Evaluation of Potential Fluctuation at Time of Repeated Use]

The above-mentioned electrophotographic apparatus was placed under an environment at 23° C./50% RH. The conditions of a charging device and an exposing device were set so that the charge potential of the electrophotographic photosensitive member was +600 V and the exposure potential thereof was +200 V, and the conditions of a developing device were set so that the developing potential was +400 V.

A character image having a print percentage of 1% was repeatedly formed on 10,000 sheets of A4-size plain paper in monochromatic color in a black station in which the electrophotographic photosensitive member was set. An initial exposure potential was compared to an exposure potential after the repeated formation of the image on the 10,000 sheets, and the difference therebetween was defined as a value (ΔVl) of potential fluctuation. After the completion of the passage of the 10,000 sheets, the apparatus was left for 5 minutes, and a cartridge for development was replaced with a potential measuring device. Then, an exposure potential (Vlb) after repeated use was measured. The difference between the exposure potential after the repeated use and an initial exposure potential (Vla) was defined as an exposure potential fluctuation amount (ΔVl=|Vlb|−|Vla|).

The results of the evaluation based on the following evaluation criteria are shown in Table 3.

### (Evaluation Criteria of ΔVl)

A: The ΔVl is 0 V or more and less than 30 V (excellent).
B: The ΔVl is 30 V or more and less than 40 V (slightly excellent).
C: The ΔVl is 40 V or more and less than 50 V (acceptable level in the present invention).
D: The ΔVl is 50 V or more (unacceptable level in the present invention).

### Examples 2 to 23 and Comparative Examples 1 and 2

Electrophotographic apparatus were each evaluated in the same manner as in Example 1 except that the kind of the electrophotographic photosensitive member was changed as shown in Table 3. The evaluation results are shown in Table 3.

TABLE 3

| | | | | After |
|---|---|---|---|---|
| | Electrophotographic | | | passage of |
| | photosensitive | | Pattern | 10,000 sheets |
| | member | Developer | memory | ΔVl [V] |
| Example 1 | 1 | 1 | B | A |
| Example 2 | 2 | 1 | C | A |
| Example 3 | 3 | 1 | B | A |
| Example 4 | 4 | 1 | B | A |
| Example 5 | 5 | 1 | B | B |
| Example 6 | 6 | 1 | C | A |
| Example 7 | 7 | 1 | B | A |
| Example 8 | 8 | 1 | B | C |
| Example 9 | 9 | 1 | B | A |
| Example 10 | 10 | 1 | C | A |
| Example 11 | 11 | 1 | B | A |
| Example 12 | 12 | 1 | A | A |
| Example 13 | 13 | 1 | B | A |
| Example 14 | 14 | 1 | A | A |
| Example 15 | 15 | 1 | A | A |
| Example 16 | 16 | 1 | A | B |
| Example 17 | 17 | 1 | B | A |
| Example 18 | 18 | 1 | A | A |
| Example 19 | 19 | 1 | A | C |
| Example 20 | 20 | 1 | A | A |
| Example 21 | 21 | 1 | A | A |
| Example 22 | 22 | 1 | A | C |
| Example 23 | 23 | 1 | A | A |
| Comparative | 24 | 1 | D | A |
| Example 1 | | | | |
| Comparative | 25 | 1 | D | A |
| Example 2 | | | | |

### [Production Example 2 of Toner]

### <Production of Amorphous Resin A1>

Polyethylene terephthalate (molecular weight: 2,000, intrinsic viscosity: 0.1):20.9 parts (42.0 mol %)
Propylene oxide adduct of bisphenol A (average number of moles added: 2.0 mol): 47.4 parts (29.0 mol %)
Terephthalic acid: 15.8 parts (18.3 mol %)
Dodecenylsuccinic acid: 15.8 parts (10.6 mol %)
Titanium tetrabutoxide (esterification catalyst): 0.5 part
Gallic acid (promoter): 0.1 part

The above-mentioned materials were weighed in a reaction vessel with a condenser, a stirring machine, a nitrogen-introducing tube, and a thermocouple. The molar ratio of polyethylene terephthalate is a value as the number of units obtained by adding up the number of units derived from ethylene glycol and the number of units derived from terephthalic acid.

Further, the materials were subjected to a reaction for 5 hours while the pressure in the reaction vessel was reduced to 8.3 kPa and the temperature therein was maintained at 200° C. After it was confirmed that the weight-average molecular weight reached 6,700, the temperature was reduced so that the reaction was stopped. Thus, an amorphous resin A1 having a polyethylene terephthalate segment in a molecule thereof was obtained. The physical property of the amorphous resin A1 obtained by the above-mentioned measurement method is shown in Table 4-1.

### <Production of Amorphous Resins A2 to A11>

Amorphous resins A2 to A11 each having a polyethylene terephthalate segment in a molecule thereof were each obtained by performing a reaction in the same manner as in the production of the amorphous resin A1 except that the kinds and numbers of parts of polyethylene terephthalate and polymerizable monomers were changed as shown in Tables 4-1 to 4-4. The physical properties of the amorphous resins A2 to A11 obtained by the above-mentioned measurement method are shown in Tables 4-1 to 4-4.

TABLE 4-1

| | | Amorphous resin | | Amorphous resin | | Amorphous resin | |
|---|---|---|---|---|---|---|---|
| | | A1 | | A2 | | A3 | |
| | | Number | | Number | | Number | |
| | | of parts | mol % | of parts | mol % | of parts | mol % |
| Polyethylene terephthalate | | 20.9 | 42.0 | 11.0 | 24.9 | 27.0 | 49.9 |
| Alcohol | BPA-PO | 47.4 | 29.0 | 53.4 | 37.6 | 43.8 | 25.1 |
| component | BPA-EO | | | | | | |
| Carboxylic | Terephthalic acid | 15.8 | 18.3 | 17.8 | 23.7 | 14.6 | 15.8 |
| acid | Dodecenylsuccinic | 15.8 | 10.6 | 17.8 | 13.8 | 14.6 | 9.2 |
| component | acid | | | | | | |
| | Tetradecanedioic acid | | | | | | |
| | Suberic acid | | | | | | |
| | Octadecanedioic acid | | | | | | |
| | Adipic acid | | | | | | |
| | Eicosanedioic acid | | | | | | |
| | Trimellitic acid | | | | | | |
| Physical | SP | 11.30 | | 11.10 | | 11.44 | |
| property | | | | | | | |

TABLE 4-2

| | | Amorphous resin | | Amorphous resin | | Amorphous resin | |
|---|---|---|---|---|---|---|---|
| | | A4 | | A5 | | A6 | |
| | | Number | | Number | | Number | |
| | | of parts | mol % | of parts | mol % | of parts | mol % |
| Polyethylene terephthalate | | 22.7 | 43.1 | 22.6 | 41.1 | 23.0 | 44.7 |
| Alcohol | BPA-PO | 50.6 | 29.8 | 55.0 | 29.5 | 52.2 | 30.9 |
| component | BPA-EO | | | | | | |
| Carboxylic | Terephthalic acid | 16.9 | 18.8 | 5.5 | 5.6 | 17.4 | 19.5 |
| acid | Dodecenylsuccinic | | | | | | |
| component | acid | | | | | | |
| | Tetradecanedioic acid | 10.1 | 8.3 | | | | |
| | Suberic acid | | | 16.0 | 23.8 | | |
| | Octadecanedioic acid | | | | | 7.4 | 4.9 |
| | Adipic acid | | | | | | |
| | Eicosanedioic acid | | | | | | |
| | Trimellitic acid | | | | | | |
| Physical | SP | 11.30 | | 11.30 | | 11.30 | |
| property | | | | | | | |

TABLE 4-3

| | | Amorphous resin | | Amorphous resin | | Amorphous resin | |
|---|---|---|---|---|---|---|---|
| | | A7 | | A8 | | A9 | |
| | | Number | | Number | | Number | |
| | | of parts | mol % | of parts | mol % | of parts | mol % |
| Polyethylene terephthalate | | 10.0 | 22.9 | 28.5 | 51.7 | 22.6 | 41.1 |
| Alcohol | BPA-PO | 54.0 | 38.6 | 42.9 | 24.2 | 55.0 | 29.5 |
| component | BPA-EO | | | | | | |
| Carboxylic | Terephthalic acid | 18.0 | 24.3 | 14.3 | 15.2 | 5.5 | 5.6 |
| acid | Dodecenylsuccinic | 18.0 | 14.1 | 14.3 | 8.9 | | |
| component | acid | | | | | | |
| | Tetradecanedioic acid | | | | | | |
| | Suberic acid | | | | | | |
| | Octadecanedioic acid | | | | | | |
| | Adipic acid | | | | | 16.0 | 23.8 |
| | Eicosanedioic acid | | | | | | |
| | Trimellitic acid | | | | | | |
| Physical | SP | 11.08 | | 11.47 | | 11.30 | |
| property | | | | | | | |

TABLE 4-4

| | | Amorphous resin A10 | | Amorphous resin A11 | |
|---|---|---|---|---|---|
| | | Number | | Number | |
| | | of parts | mol % | of parts | mol % |
| Polyethylene terephthalate | | 23.0 | 45.1 | 28.7 | 55.7 |
| Alcohol | BPA-PO | 52.4 | 31.1 | 36.6 | 21.7 |
| component | BPA-EO | | | 14.6 | 9.5 |
| Carboxylic | Terephthalic acid | 17.5 | 19.6 | 2.2 | 2.5 |
| acid | Dodecenylsuccinic | | | 9.3 | 6.1 |
| component | acid | | | | |
| | Tetradecanedioic | | | | |
| | acid | | | | |
| | Suberic acid | | | | |
| | Octadecanedioic | | | | |
| | acid | | | | |
| | Adipic acid | | | | |
| | Eicosanedioic acid | 7.0 | 4.2 | | |
| | Trimellitic acid | | | 8.6 | 4.5 |
| Physical | SP | 11.30 | | 11.45 | |
| property | | | | | |

The abbreviations in Tables 4-1 to 4-4 are as described below.
BPA-PO: propylene oxide adduct of bisphenol A (average number of moles added: 2.0 mol)
BPA-EO: ethylene oxide adduct of bisphenol A (average number of moles added: 2.0 mol)

### <Production of Amorphous Resin B1>

Polyethylene terephthalate (molecular weight: 2,000, intrinsic viscosity: 0.1): 4.1 parts (9.8 mol %)
Propylene oxide adduct of bisphenol A (average of moles added: 2.0 mol): 57.8 parts (42.8 mol %)
Terephthalic acid: 29.9 parts (41.9 mol %)
Trimellitic acid: 7.0 parts (4.5 mol %)
Stearic acid: 1.2 parts (1.0 mol %)
Titanium tetrabutoxide (esterification catalyst): 0.5 part
Gallic acid (promoter): 0.1 part

The above-mentioned materials were weighed in a reaction vessel with a condenser, a stirring machine, a nitrogen-introducing tube, and a thermocouple. Next, the flask was purged with a nitrogen gas, and then the temperature therein was gradually increased while the materials were stirred. The materials were subjected to a reaction for 2 hours while being stirred at a temperature of 200° C.

Further, the materials were subjected to a reaction for 5 hours while the pressure in the reaction vessel was reduced to 8.3 kPa and the temperature therein was maintained at 200° C. After it was confirmed that the weight-average molecular weight reached 1,000, the temperature was reduced so that the reaction was stopped. Thus, an amorphous resin B1 was obtained. The physical property of the amorphous resin B1 obtained by the above-mentioned measurement method was an SP value of 11.54 (cal/cm³)^{0.5}.

### <Production of Crystalline Polyester C1>

Ethylene glycol: 10.2 parts (48.2 mol %)
Tetradecanedioic acid: 81.3 parts (48.3 mol %)
Behenic acid: 8.5 parts (3.5 mol %)
Titanium tetrabutoxide (esterification catalyst): 0.5 part

The above-mentioned materials were weighed in a reaction vessel with a condenser, a stirring machine, a nitrogen-introducing tube, and a thermocouple. Next, the flask was purged with a nitrogen gas, and then the temperature therein was gradually increased while the materials were stirred. The materials were subjected to a reaction for 2 hours while being stirred at a temperature of 200° C.

Further, the materials were subjected to a reaction for 5 hours while the pressure in the reaction vessel was reduced to 8.3 kPa and the temperature therein was maintained at 200° C. After that, the temperature was reduced so that the reaction was stopped. Thus, a crystalline polyester C1 was obtained. The physical property of the crystalline polyester C1 obtained by the above-mentioned measurement method was an SP value of 10.09 (cal/cm³)^{0.5}.

### <Production Example of Toner 2>

Amorphous resin A1: 66 parts
Amorphous resin B1: 34 parts
Crystalline polyester C1: 10 parts
Fischer-Tropsch wax (peak temperature of maximum endothermic peak: 100° C.): 5 parts
Carbon black: 5 parts
Trisodium phosphate: 0.160 part
Charge control agent BONTRON P-51 (manufactured by Orient Chemical Industries Co., Ltd.): 0.5 part

The above-mentioned materials were mixed with a Henschel mixer (model FM-75, manufactured by Mitsui Mining Co., Ltd.) at a number of rotations of 1,500 rpm for a time of rotation of 5 min, and then the mixture was kneaded with a twin-screw kneading machine set to a temperature of 130° C. (model PCM-30, manufactured by Ikegai Corp.). The kneaded product thus obtained was cooled and coarsely pulverized with a hammer mill to 1 mm or less to provide a coarsely pulverized product. The coarsely pulverized product thus obtained was finely pulverized with a mechanical pulverizer (T-250, manufactured by Turbo Kogyo Co., Ltd.). Further, the finely pulverized product was classified with Faculty (F-300, manufactured by Hosokawa Micron Corporation) to provide toner particles 2. Operating conditions were as follows: the number of rotations of a classification rotor was set to 11,000 rpm and the number of rotations of a dispersion rotor was set to 7,200 rpm.

| | | |
|---|---|---|
| Toner particles 2: | 95 | parts |
| Large-particle-diameter inorganic | 4 | parts |
| fine particles: fumed silica subjected | | |
| to surface treatment with | | |
| hexamethyldisilazane (number-based | | |
| median diameter (D50): 120 nm) | | |
| Small-particle-diameter inorganic | 1 | part |
| fine particles: titanium oxide fine | | |
| particles subjected to surface | | |
| treatment with isobutyltrimethoxysilane | | |
| (number-based median diameter | | |
| (D50): 10 nm) | | |

The above-mentioned materials were mixed with a Henschel mixer (model FM-75, manufactured by Mitsui Miike Chemical Engineering Machinery, Co., Ltd.) at a number of rotations of 1,900 rpm for a time of rotation of 10 min to provide a toner 2 showing positive chargeability. The physical properties of the toner 2 obtained by the above-mentioned measurement method are shown in Table 5.

### <Production Examples of Toners 3 to 19>

Toners 3 to 19 were each obtained by performing the same operation as that in the production example of the toner 2 except that the kinds and numbers of parts of the amorphous resin A and the additive were changed as shown in Table 5 in the production example of the toner 2. The physical properties of the toners 3 to 19 obtained by the above-mentioned measurement method are shown in Table 5.

TABLE 5

| | Internal addition formulation and physical properties | | | | | | | | | |
|---|---|---|---|---|---|---|---|---|---|---|
| | Amorphous | | Amorphous | | Crystalline | | | | | SP_{A} − |
| Toner | resin A | | resin B | | polyester C | | Additive | | W_{P} | SP_{C} |
| Kind | Kind | Part(s) | Kind | Part(s) | Kind | Part(s) | Kind | Part(s) | ppm | — |
| 2 | 1 | 66 | 1 | 34 | 1 | 10 | PNa | 0.160 | 250 | 1.21 |
| 3 | 2 | 66 | 1 | 34 | 1 | 10 | PNa | 0.160 | 250 | 1.01 |
| 4 | 3 | 66 | 1 | 34 | 1 | 10 | PNa | 0.160 | 250 | 1.35 |
| 5 | 1 | 66 | 1 | 34 | 1 | 10 | PNa | 0.320 | 500 | 1.21 |
| 6 | 1 | 66 | 1 | 34 | 1 | 10 | PNa | 0.013 | 20 | 1.21 |
| 7 | 1 | 66 | 1 | 34 | 1 | 10 | PNa | 0.004 | 5 | 1.21 |
| 8 | 1 | 66 | 1 | 34 | 1 | 10 | PF | 0.320 | 250 | 1.21 |
| 9 | 4 | 66 | 1 | 34 | 1 | 10 | PNa | 0.160 | 250 | 1.21 |
| 10 | 5 | 66 | 1 | 34 | 1 | 10 | PNa | 0.160 | 250 | 1.21 |
| 11 | 6 | 66 | 1 | 34 | 1 | 10 | PNa | 0.160 | 250 | 1.21 |
| 12 | 7 | 66 | 1 | 34 | 1 | 10 | PNa | 0.160 | 250 | 0.99 |
| 13 | 8 | 66 | 1 | 34 | 1 | 10 | PNa | 0.160 | 250 | 1.38 |
| 14 | 1 | 66 | 1 | 34 | 1 | 10 | PNa | 0.400 | 600 | 1.21 |
| 15 | 1 | 66 | 1 | 34 | 1 | 10 | — | — | 0 | 1.21 |
| 16 | 1 | 66 | 1 | 34 | 1 | 10 | PNa | 0.002 | 3 | 1.21 |
| 17 | 9 | 66 | 1 | 34 | 1 | 10 | PNa | 0.160 | 250 | 1.21 |
| 18 | 10 | 66 | 1 | 34 | 1 | 10 | PNa | 0.160 | 250 | 1.21 |
| 19 | 11 | 66 | 1 | 34 | 1 | 10 | PNa | 0.160 | 250 | 1.36 |

The abbreviations in Table 5 are as described below.
PNa: trisodium phosphate
PF: triphenyl phosphate

### <Production Examples of Developers 2 to 19>

Developers 2 to 19 were each obtained by performing the same operation as that in the production example of the developer 1 except that the kind of the toner was changed as shown in Table 6.

TABLE 6

| Developer | Toner | Carrier |
|---|---|---|
| Kind | Kind | Kind |
| 1 | 1 | 1 |
| 2 | 2 | 1 |
| 3 | 3 | 1 |
| 4 | 4 | 1 |
| 5 | 5 | 1 |
| 6 | 6 | 1 |
| 7 | 7 | 1 |
| 8 | 8 | 1 |
| 9 | 9 | 1 |
| 10 | 10 | 1 |
| 11 | 11 | 1 |
| 12 | 12 | 1 |
| 13 | 13 | 1 |
| 14 | 14 | 1 |
| 15 | 15 | 1 |
| 16 | 16 | 1 |
| 17 | 17 | 1 |
| 18 | 18 | 1 |
| 19 | 19 | 1 |

### Examples 24 to 41

The evaluation of each of the electrophotographic apparatus was performed in the same manner as in Example 1 except that the kinds of the electrophotographic photosensitive member and the developer were changed as shown in Table 7. In addition, the evaluation of scratch resistance and low-temperature fixability was also performed by the following method. The evaluation results are shown in Table 7.

### [Evaluation of Scratch Resistance/Low-Temperature Fixability]

A reconstructed machine of a printer for digital commercial printing “imagePRESS C800” manufactured by Canon Inc. was used as an image-forming apparatus. The electrophotographic photosensitive member 12 was mounted to a cyan station, and the developer 2 was set in a developing device of the cyan station. As the reconstructed points of the apparatus, changes were made so that its fixation temperature and process speed, the DC voltage V_{DC} of a developer-carrying member, the charging voltage V_{D} of the electrophotographic photosensitive member, and laser power were able to be freely set. Image output evaluation was performed as follows: an FFh image (solid image) having a desired image print percentage was output and subjected to evaluations of scratch resistance and low-temperature fixability to be described later with the V_{DC}, the V_{D}, and the laser power being adjusted so as to achieve a desired toner laid-on level on the FFh image on paper. FFh is a value obtained by representing 256 gradations in hexadecimal notation; 00h represents the first gradation (white portion) of the 256 gradations, and FFh represents the 256th gradation (solid portion) of the 256 gradations.

### [Evaluation 3: Scratch Resistance]

Paper: UPM FINESSE GLOSS 300GSM
Toner laid-on level on paper: 0.05 mg/cm² (2Fh image)
(The toner laid-on level was adjusted based on the DC voltage V_{DC} of the developer-carrying member, the charging voltage V_{D} of the electrophotographic photosensitive member, and the laser power. The charging voltage V_{D} of the electrophotographic photosensitive member was set to positive charge.)
Evaluation image: An image measuring 3 cm×15 cm was arranged at the center of the above-mentioned A4 paper.
Fixing test environment: Normal-temperature and normal-humidity environment (temperature of 23° C./humidity of 50% RH (hereinafter referred to as “N/N”))
Fixing temperature: 180° C.
Process speed: 377 mm/sec

The above-mentioned evaluation image was output and evaluated for scratch resistance. Specifically, through use of a surface property tester HEIDON TYPE 14FW manufactured by SHINTO Scientific Co., Ltd., a 200 g weight was placed on the surface of the image, the surface was scratched with a needle having a diameter of 0.75 mm at a speed of 60 mm/min and a length of 30 mm, and the image was evaluated based on the scratches that appeared thereon. The area ratio of toner peeling was determined by binarizing the area in which the toner peeling occurred with respect to the scratched area by image processing.

### (Evaluation Criteria)

A: 0.0%
B: 0.1% or more and less than 1.1%
C: 1.1% or more

### [Evaluation 4: Low-Temperature Fixability]

Paper: GFC-081 (81.0 g/m²) (sold from Canon Marketing Japan Inc.)
Toner laid-on level on paper: 0.50 mg/cm²
(The toner laid-on level was adjusted based on the DC voltage V_{DC} of the developer-carrying member, the charging voltage V_{D} of the electrophotographic photosensitive member, and the laser power. The charging voltage V_{D} of the electrophotographic photosensitive member was set to positive charge.)
Evaluation image: An image measuring 2 cm×5 cm was arranged at the center of the above-mentioned A4 paper.
Test environment: Low-temperature and low-humidity environment: temperature of 15° C./humidity of 10% RH (hereinafter referred to as “L/L”)
Fixing temperature: 150° C.
Process speed: 630 mm/sec

The evaluation image was output, and low-temperature fixability was evaluated. The value of an image density reduction ratio was used as an indicator for evaluating the low-temperature fixability.

Through use of an X-Rite color reflection densitometer (500 SERIES: manufactured by X-Rite, Inc.), the image density at the central portion of the image was measured first. Next, the fixed image was rubbed (back and forth 5 times) with lens-cleaning paper with the application of a load of 4.9 kPa (50 g/cm²) to the portion at which the image density was measured, and the image density was measured again.

Then, the reduction ratio of the image density after the rubbing as compared to that before the rubbing was calculated by using the following equation. The resultant image density reduction ratio was evaluated in accordance with the following evaluation criteria. A case of being evaluated as A to C was judged to be satisfactory.

Image density reduction ratio (%)−(image density before rubbing−image density after rubbing)/image density before rubbing×100

### (Evaluation Criteria)

A: An image density reduction ratio of less than 3%
B: An image density reduction ratio of 3% or more and less than 10%
C: An image density reduction ratio of 10% or more

TABLE 7

| | | | | | | After | | |
|---|---|---|---|---|---|---|---|---|
| | | | | | | passage | | |
| | | | | | | of | | |
| | Electrophotographic | | | | | 10,000 | | |
| | photosensitive | | | | | sheets | Low- | |
| | member | Developer | Toner | Carrier | Pattern | ΔV1 | temperature | Scratch |
| | Kind | Kind | Kind | Kind | memory | [V] | fixability | resistance |
| Example 24 | 12 | 2 | 2 | 1 | A | A | A | A |
| Example 25 | 12 | 3 | 3 | 1 | A | A | A | B |
| Example 26 | 12 | 4 | 4 | 1 | A | A | B | B |
| Example 27 | 12 | 5 | 5 | 1 | A | A | B | B |
| Example 28 | 12 | 6 | 6 | 1 | A | A | A | B |
| Example 29 | 12 | 7 | 7 | 1 | A | A | A | B |
| Example 30 | 12 | 8 | 8 | 1 | A | A | A | B |
| Example 31 | 12 | 9 | 9 | 1 | A | A | B | B |
| Example 32 | 12 | 10 | 10 | 1 | A | A | B | B |
| Example 33 | 12 | 11 | 11 | 1 | A | A | A | B |
| Example 34 | 12 | 12 | 12 | 1 | A | A | A | C |
| Example 35 | 12 | 13 | 13 | 1 | A | A | C | C |
| Example 36 | 12 | 14 | 14 | 1 | A | A | C | C |
| Example 37 | 12 | 15 | 15 | 1 | A | A | A | C |
| Example 38 | 12 | 16 | 16 | 1 | A | A | A | C |
| Example 39 | 12 | 17 | 17 | 1 | A | A | C | C |
| Example 40 | 12 | 18 | 18 | 1 | A | A | A | C |
| Example 41 | 12 | 19 | 19 | 1 | A | A | C | C |

In the toner to be used in the electrophotographic apparatus of the present disclosure, polyethylene terephthalate regenerated from a spent PET bottle or the like can be used as a toner material, and hence the technologies described in this specification have the potential to contribute to the achievement of a sustainable society, such as a decarbonized society/circular society.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-003389, filed Jan. 12, 2024, Japanese Patent Application No. 2024-146848, filed Aug. 28, 2024, and Japanese Patent Application No. 2024-176750, filed Oct. 8, 2024, which are hereby incorporated by reference herein in their entirety.

What is claimed is:

1. An electrophotographic apparatus comprising:
an electrophotographic photosensitive member;
a charging unit configured to charge a surface of the electrophotographic photosensitive member;
an image exposing unit configured to irradiate the charged surface of the electrophotographic photosensitive member with image exposure light to form an electrostatic latent image on the surface of the electrophotographic photosensitive member;
a developing unit, which includes a toner, and which is configured to develop the electrostatic latent image with the toner to form a toner image on the surface of the electrophotographic photosensitive member;
a transfer unit configured to transfer the toner image from the surface of the electrophotographic photosensitive member onto a transfer material;
a cleaning unit configured to remove a residual toner remaining on the surface of the electrophotographic photosensitive member with a cleaning blade after the toner image is transferred from the surface of the electrophotographic photosensitive member onto the transfer material; and
a fixing unit configured to fix the toner image transferred onto the transfer material to the transfer material,
wherein the electrophotographic photosensitive member includes a monolayer-type photosensitive layer containing a binder resin, a charge-generating substance, a hole-transporting substance, an electron-transporting substance, and silicon atom-containing particles,
wherein the monolayer-type photosensitive layer is a surface layer of the electrophotographic photosensitive member,
wherein the charge-generating substance is one of metal-free phthalocyanine or oxytitanium phthalocyanine,
wherein the silicon atom-containing particles are one of silica particles or silicone resin particles, and
wherein the toner includes toner particles each containing a polyester resin having a polyethylene terephthalate segment.

2. The electrophotographic apparatus according to claim 1, wherein a content of the silicon atom-containing particles in the surface layer is 0.1 mass % or more and 10.0 mass % or less with respect to a total mass of the surface layer.

3. The electrophotographic apparatus according to claim 1, wherein a content of the silicon atom-containing particles in the surface layer is 10 mass % or more and 1,400 mass % or less with respect to a content of the charge-generating substance in the surface layer.

4. The electrophotographic apparatus according to claim 1, wherein the silicon atom-containing particles have a number-average primary particle diameter of 10 nm or more and 2,000 nm or less.

5. The electrophotographic apparatus according to claim 1, wherein the silicon atom-containing particles are silicone resin particles.

6. The electrophotographic apparatus according to claim 1,
wherein the toner is a toner including toner particles each containing a binder resin,
wherein the binder resin contains an amorphous resin A and a crystalline polyester C, and the amorphous resin A is the polyester resin and has, as structures for forming a polyester backbone,
(i) the polyethylene terephthalate segment, and
(ii) at least one structure selected from the group consisting of units represented by the following formulae (1) to (4): 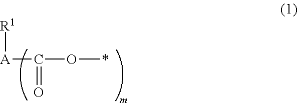
where R¹ represents an alkyl group having 6 to 16 carbon atoms or an alkenyl group having 6 to 16 carbon atoms,
A represents a hydrocarbon group,
“*” represents a bonding site in the polyester backbone, and
“m” represents an integer of 2 or more; 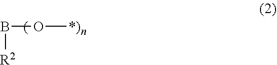
where R² represents an alkyl group having 6 to 16 carbon atoms or an alkenyl group having 6 to 16 carbon atoms,
B represents a hydrocarbon group,
“*” represents a bonding site in the polyester backbone, and
“n” represents an integer of 2 or more; 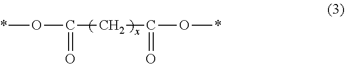
where “*” represents a bonding site in the polyester backbone, and
“x” represents an integer of from 6 to 16; 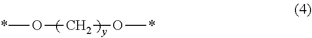
where “*” represents a bonding site in the polyester backbone, and
“y” represents an integer of from 6 to 16,
wherein, when an SP value of the amorphous resin A is represented by SP_{A} (cal/cm³)^{0.5}, and an SP value of the crystalline polyester C is represented by SP_{C} (cal/cm³)^{0.5}, the SP_{A} and the SP_{C} satisfy the following formula (C):
1.00≤SP_{A}−SP_{C}≤1.35 (C),
wherein the toner contains a phosphorus element derived from a phosphorus compound, and
wherein, when a content of the phosphorus element in the toner based on a mass of the toner is represented by W_{P} (ppm), the W_{P} satisfies the following formula (D):
5≤W_{P}≤500 (D).

7. The electrophotographic apparatus according to claim 6, wherein the W_{P} satisfies the following formula (E):
20≤W_{P}≤500 (E).
